(19) United States
(12) Patent Application Publication
(10) Pub. No.: US 2024/0163552 A1
(43) Pub. Date: May 16, 2024

(54) INFORMATION PROCESSING APPARATUS, INFORMATION PROCESSING METHOD, AND PROGRAM

(71) Applicant: SONY GROUP CORPORATION, TOKYO (JP)

(72) Inventors: AYUMI NAKAGAWA, TOKYO (JP); KEIICHIRO TANIGUCHI, TOKYO (JP); TAKESHI OGITA, TOKYO (JP); DAISUKE YAMAMOTO, TOKYO (JP); ATSUTAKA ITO, TOKYO (JP); AKIKO YOSHIMOTO, TOKYO (JP); MAYUMI UEMURA, TOKYO (JP)

(21) Appl. No.: 18/550,358

(22) PCT Filed: Jan. 6, 2022
(86) PCT No.: PCT/JP2022/000227

§ 371 Date: Sep. 13, 2023

(30) Foreign Application Priority Data
Mar. 25, 2021 (JP) 2021-051433

(51) Int. Cl. H04N 23/60

(52) U.S. Cl. CPC H04N 23/64

(57) ABSTRACT

[Object] To provide an information processing apparatus, an information processing method, and a program that make it possible to properly provide information related to an image-capturing apparatus through a tactile sense.

[Solving Means] Solution to Problem

An information processing apparatus according to an embodiment of the present technology includes a controller. The controller controls oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including a camera body that includes the oscillation device and an imaging device that captures an image of a subject.

### TECHNICAL FIELD

The present technology relates to an information processing apparatus, an information processing method, and a program.

### BACKGROUND ART

Patent Literature 1 discloses an image-capturing apparatus that provides image-capturing-related information provided to a camera operator, using a bone oscillation transmitting device for transmitting oscillation to a bone of the camera operator. The bone oscillation transmitting device is provided at a position corresponding to a position where a cheek of the camera operator is situated when the camera operator uses an electronic viewfinder.

### CITATION LIST

### Patent Literature

Patent Literature 1: Japanese Patent Application Laid-open No. 2007-199259

### DISCLOSURE OF INVENTION

### Technical Problem

In such a field, there is a need for a technology that enables a camera operator to properly perceive information related to an image-capturing apparatus.

In view of the circumstances described above, it is an object of the present technology to provide an information processing apparatus, an information processing method, and a program that make it possible to properly provide information related to an image-capturing apparatus through a tactile sense.

### Solution to Problem

In order to achieve the object described above, an information processing apparatus according to an embodiment of the present technology includes a controller.

The controller controls oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including a camera body that includes the oscillation device and an imaging device that captures an image of a subject.

This configuration makes it possible to properly provide information related to the image-capturing apparatus through a tactile sense.

The oscillation may indicate information related to the image-capturing apparatus.

The information related to the image-capturing apparatus may include at least one of operation information regarding an operation of the image-capturing apparatus, reminder information, operation information regarding an operation of an attachment device that is attached to the camera body, or image-capturing information that is acquired by the imaging device.

The operation information regarding an operation of the image-capturing apparatus may include information regarding a state in which the subject is in focus, information regarding start of exposure performed on the imaging device, and information regarding completion of the exposure.

The image-capturing apparatus may include a shutter button that is operated to be half-pressed and fully pressed,
the controller may control the oscillation of the oscillation device, which indicates the state in which the subject is in focus and is provided in response to the shutter button being half-pressed, and
the controller may control the oscillation of the oscillation device, which indicates the start of the exposure and is provided in response to the shutter button being fully pressed, and the oscillation of the oscillation device, which indicates the completion of the exposure and is provided in response to the shutter button being fully pressed.

The controller may perform control such that the oscillation being provided by the oscillation device and indicating the state in which the subject is in focus differs depending on a focal length.

The image-capturing information may include information regarding whether a captured image that is acquired by the imaging device is a normal image or an error image, and
the controller may control the oscillation of the oscillation device such that oscillation indicating that the error image has been acquired is different from oscillation indicating that the normal image has been acquired.

During exposure performed on the imaging device, the controller may perform control such that the oscillation of the oscillation device is set to off.

A drive signal of oscillation indicating the reminder information may include a signal that is not given out when an oscillation mode for the oscillation device is off or a signal that is given out when the oscillation mode is off,
when the controller receives, during exposure performed on the imaging device, the reminder information including the signal not being given out when the oscillation mode is off, the controller may control the oscillation device such that the oscillation indicating the reminder information is generated after the exposure performed on the imaging device is completed, and
when the controller receives, during exposure performed on the imaging device, the reminder information including the signal being given out when the oscillation mode is off, the controller may control the oscillation device such that the oscillation indicating the reminder information is generated during the exposure performed on the imaging device.

The reminder information may include at least one of information regarding a remaining life of a battery that serves as a drive power supply used to drive the image-capturing apparatus, or information regarding the image-capturing-environment information.

A plurality of the attachment devices different from each other may be attached to the image-capturing apparatus, and
the controller may control the oscillation of the oscillation device such that oscillation indicating the operation information regarding an operation of the attachment device differs depending on the attachment device of the plurality of the attachment devices.

The controller may perform control such that first oscillation and second oscillation that respectively indicate the different pieces of information related to the image-capturing apparatus are distinguishable by the camera operator.

The image-capturing-setting information may include at least one of a setting of a shutter speed, a setting of a frame rate, a setting of a single-shooting mode or a consecutive-shooting mode, or a setting of the image-capturing environment.

The state information regarding a state of the image-capturing apparatus may include at least one of type information regarding the type of the attachment device attached to the camera body, form information regarding the form of the attachment device, holding-state information regarding a state in which the camera operator holds the image-capturing apparatus, or information regarding a remaining life of a drive power supply used to drive the image-capturing apparatus and power consumption of the camera body.

The image-capturing apparatus may include a zoom lens, and
the controller may control the oscillation of the oscillation device taking into consideration oscillation provided during driving of the zoom lens.

The controller may control the oscillation of the oscillation device taking into consideration oscillation sound produced due to the oscillation device.

The image-capturing apparatus may include a mechanical shutter, and the controller may control the oscillation of the oscillation device taking into consideration oscillation provided when the mechanical shutter is operated.

The controller may control next oscillation of the oscillation device using oscillation information regarding oscillation of the image-capturing apparatus.

An information processing method according to an embodiment of the present technology includes controlling oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.

A program causes an information processing apparatus to perform a process including controlling oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.

### BRIEF DESCRIPTION OF DRAWINGS

FIG. 1 is a set of a front view and a side view of an image-capturing apparatus according to embodiments of the present technology.

FIG. 2 is a block diagram illustrating a function and a configuration of the image-capturing apparatus according to the embodiments of the present technology.

FIG. 3 schematically illustrates an internal configuration of the image-capturing apparatus according to the embodiments of the present technology in which a lens unit is attached to a camera body of the image-capturing apparatus.

FIG. 4 is a front view of an imaging device, a mechanical front shutter curtain, and a mechanical rear shutter curtain that are included in a mechanical shutter mechanism of the image-capturing apparatus according to the embodiments of the present technology, as viewed from a lens side in an optical-axis direction.

FIG. 5 schematically illustrates an example in which oscillation is provided by the image-capturing apparatus according to the embodiments of the present technology.

FIG. 6 is a diagram used to describe examples in which oscillation is provided by the image-capturing apparatus according to the embodiments of the present technology, according to a length of an exposure period of time and a frame rate.

FIG. 7 is a diagram used to describe an example of providing oscillation taking into consideration oscillation due to mechanical shutter, the provision of oscillation being performed by the image-capturing apparatus according to the embodiments of the present technology.

FIG. 8 is a diagram used to describe an example of providing oscillation taking into consideration sounding of an oscillation device, the provision of oscillation being performed by the image-capturing apparatus according to the embodiments of the present technology.

FIG. 9 is a diagram used to describe an example of providing oscillation taking into consideration sounding of the oscillation device, the provision of oscillation being performed by the image-capturing apparatus according to the embodiments of the present technology.

FIG. 10 is a diagram used to describe an example of providing oscillation taking into consideration oscillation due to driving of a lens, the provision of oscillation being performed by the image-capturing apparatus according to the embodiments of the present technology.

FIG. 11 is a diagram used to describe an example of providing oscillation taking into consideration a remaining battery life and power consumption of the camera body, the provision of oscillation being performed by the image-capturing apparatus according to the embodiments of the present technology.

FIG. 12 schematically illustrates an example of provision of oscillation that is performed by the image-capturing apparatus according to the embodiments of the present technology.

FIG. 13 is a flow diagram used to describe a basic timing at which an oscillation mode is turned off when oscillation is provided by the image-capturing apparatus according to the embodiments of the present technology.

FIG. 14 is a diagram of a flow performed when reminder information including a signal that is not given out when the oscillation mode is off, is received upon provision of oscillation that is performed by the image-capturing apparatus according to the embodiments of the present technology.

FIG. 15 is a diagram of a flow performed when reminder information including a signal that is given out when the oscillation mode is off, is received upon provision of oscillation that is performed by the image-capturing apparatus according to the embodiments of the present technology.

FIG. 16 is a diagram used to describe an example of providing oscillation taking into consideration image-capturing information, the provision of oscillation being performed by the image-capturing apparatus according to the embodiments of the present technology.

FIG. 17 is a diagram used to describe an example of providing oscillation taking into consideration a focal length (a state in which a subject is in focus), the provision of oscillation being performed by the image-capturing apparatus according to the embodiments of the present technology.

FIG. 18 is a diagram used to describe an example of providing oscillation when a plurality of attachment devices is attached, the provision of oscillation being performed by the image-capturing apparatus according to the embodiments of the present technology.

FIG. 19 is a diagram used to describe provision of oscillation that is performed taking into consideration the type of attachment device to be attached, the provision of oscillation being performed by the image-capturing apparatus according to the embodiments of the present technology.

FIG. 20 is a diagram used to describe provision of oscillation that is performed taking into consideration the type of attachment device to be attached, the provision of oscillation being performed by the image-capturing apparatus according to the embodiments of the present technology.

FIG. 21 is a diagram used to describe provision of oscillation that is performed taking into consideration the type of attachment device to be attached, the provision of oscillation being performed by the image-capturing apparatus according to the embodiments of the present technology.

FIG. 22 is a diagram used to describe provision of oscillation that is performed taking into consideration the type of lens to be used and a state in which the lens is held, the provision of oscillation being performed by the image-capturing apparatus according to the embodiments of the present technology.

FIG. 23 is a diagram used to describe provision of oscillation that is performed taking into consideration a zooming state of a lens to be used and a state in which the lens is held, the provision of oscillation being performed by the image-capturing apparatus according to the embodiments of the present technology.

FIG. 24 is a diagram used to describe provision of oscillation that is performed taking into consideration a state in which a lens to be used is held, the provision of oscillation being performed by the image-capturing apparatus according to the embodiments of the present technology.

FIG. 25 is a diagram used to describe provision of oscillation that is performed taking into consideration an orientation (a pose) of the image-capturing apparatus according to the embodiments of the present technology when the image-capturing apparatus is in use.

FIG. 26 is a diagram used to describe provision of oscillation that is performed taking into consideration the occurrence of wobble of a camera operator when the image-capturing apparatus according to the embodiments of the present technology is in use.

FIG. 27 is a flow diagram used to describe an information processing method related to provision of oscillation that is performed by the image-capturing apparatus according to the embodiments of the present technology.

FIG. 28 is a diagram used to describe an example of processing data of sound acquired by a microphone of the image-capturing apparatus according to the embodiments of the present technology.

FIG. 29 is a diagram used to describe another example of the oscillation device used in the image-capturing apparatus according to the embodiments of the present technology.

FIG. 30 illustrates an example of the oscillation device (a voice coil motor) used in the image-capturing apparatus according to the embodiments of the present technology.

### MODE(S) FOR CARRYING OUT THE INVENTION

Embodiments according to the present technology will now be described below with reference to the drawings. In the following description, similar structural elements are denoted by similar reference numerals, and a description of an already described structural element may be omitted.

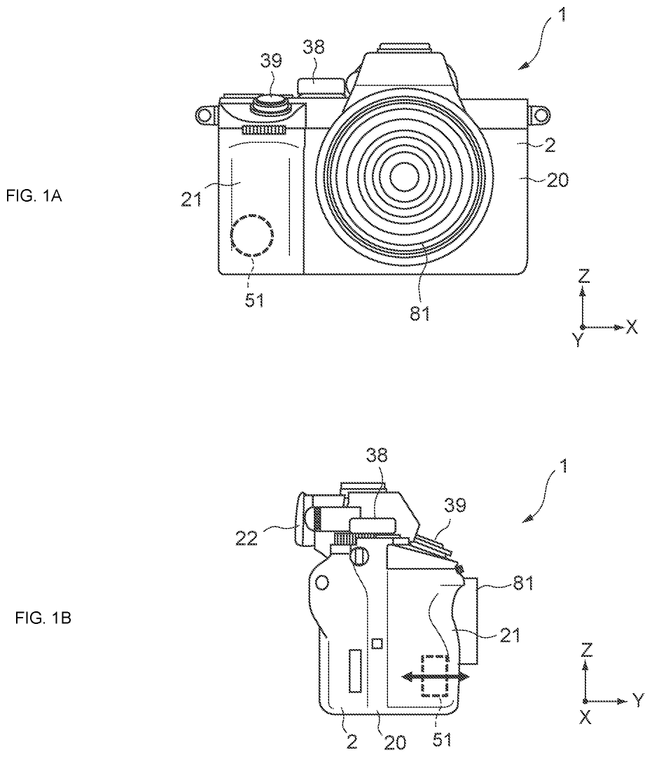

A configuration of an image-capturing apparatus is described with reference to FIGS. 1 to 3.

Note that a digital camera with an interchangeable lens is described herein as an example of an image-capturing apparatus 1 that is an example of the image-capturing apparatus. However, the image-capturing apparatus is not limited to this example. For example, the image-capturing apparatus may be a digital camera with an integrated lens, a film-based camera, a video camera, or another apparatus that can capture a still image.

FIG. 1 illustrates an appearance configuration of the image-capturing apparatus 1 according to embodiments. (A) of FIG. 1 is a front view of the image-capturing apparatus 1, and (B) of FIG. 1 is a side view of the image-capturing apparatus 1.

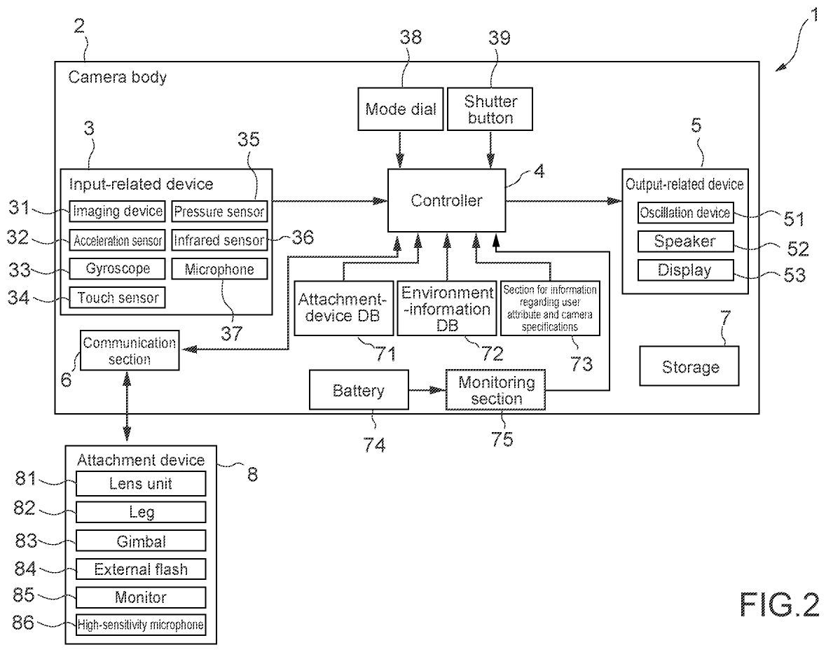

FIG. 2 is a block diagram primarily illustrating a function and an internal configuration of the image-capturing apparatus 1.

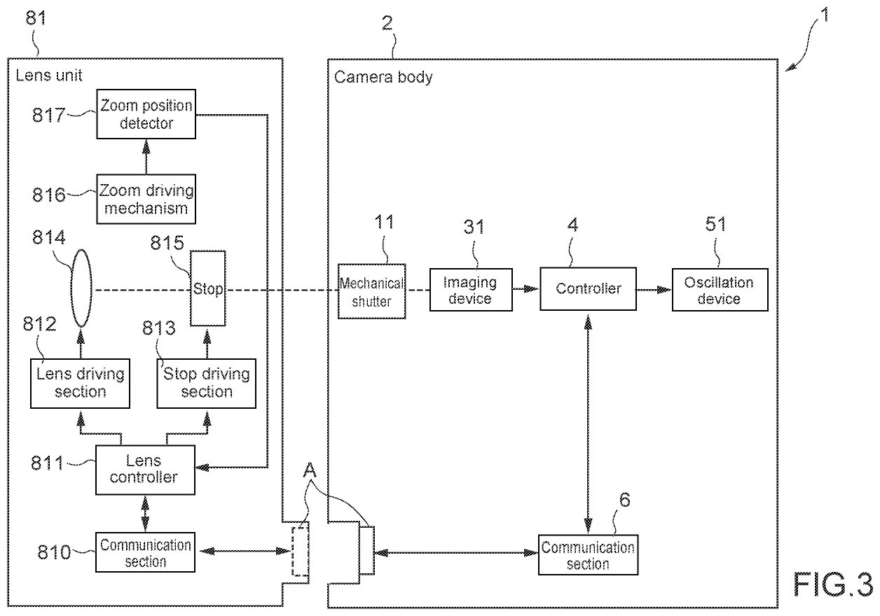

FIG. 3 schematically illustrates the internal configuration of the image-capturing apparatus in which a lens unit is attached to a camera body of the image-capturing apparatus.

<Appearance Configuration of Image-Capturing Apparatus>

As illustrated in (A) and (B) of FIG. 1, the image-capturing apparatus 1 includes a camera body 2 that serves as an information processing apparatus, and a lens unit 81 that is an interchangeable lens. The lens unit 81 is a shooting lens that is removable from the camera body 2.

The camera body 2 includes, at substantially the center of the front of the camera body 2, an annular mounting portion to which the lens unit 81 is attached, and includes, near the annular mounting portion, a removal button used to remove the lens unit 81.

The camera body 2 includes a housing 20. At a left end of the front of the housing 20 (on the right as viewed from the back of the housing 20), the housing 20 includes a grip portion 21 used to be held by a camera operator. A shutter button 39 used to give an instruction to, for example, start exposure is provided on a front side of an upper surface of the grip portion 21. Further, in addition to the shutter button 39, a mode dial 38 is provided on an upper surface of the camera body 2.

The camera operator can select a desired shooting mode by turning the mode dial 38. The mode dial 38 provides, for example, a single-shooting mode, a consecutive-shooting mode, an automatically set shooting mode, a shooting mode in which only exposure (a shutter speed and a stop) is automatically set, a stop priority mode, and a manual exposure mode.

The shutter button 39 includes a pressing switch that can detect a “half press state” of being half-pressed, and a “full press state” of being further pressed.

When the shutter button 39 is in the half press state in the shooting mode, a preparation operation for capturing an image of a subject is performed. For example, setting of an exposure control value and detection of a focal point are assumed to be the preparation operation.

Further, when the shutter button 39 is in the full press state, a shooting operation is performed. A series of operations including performing exposure on an imaging device described later, performing specified image processing on captured-image data obtained by the exposure, and recording, in a recording medium, the captured-image data on which specified image processing has been performed, is assumed to be the shooting operation.

An electronic viewfinder 22 is provided to substantially the middle of an upper portion of the back of the camera body 2. An image of a subject that comes from the lens unit 81 is led to the electronic viewfinder 22. The camera operator can visually confirm the subject by looking into the electronic viewfinder 22.

A display 53 described later is provided at substantially the center (more specifically, at a position slightly further leftward than the center) of the back of the camera body 2. The display 53 is, for example, a color liquid crystal display. The display 53 can display thereon, for example, a through-the-lens image, a captured image, and a reconstructed image. Except during image-capturing, the display 53 can display thereon, for example, a user interface screen used for mode setting.

A touch sensor 34 described later is arranged in the display 53, which makes it possible to perform a touch operation on the display 53. This enables a camera operator to perform an input operation, such as mode setting, on the display 53. For example, a touch operation performed on the display 53 makes it possible to set an image-capturing environment, such as selecting an underwater shooting mode for setting the quality in shooting with camera, and selecting a glove mode for setting a touch-panel sensitivity. Further, a touch operation performed on the display 53 makes it possible to set, for example, a shutter speed, a frame rate upon consecutive shooting, the selection of a shutter mechanism, on/off of a sound mode, and on/off of an oscillation mode.

The oscillation mode is a mode in which feedback on information related to the image-capturing apparatus can be given to a camera operator in the form of an oscillation tactile sense using an oscillation device described later.

An oscillation device 51 is provided in the housing 20 of the camera body 2. When the oscillation device 51 is driven to oscillate, this results in providing an oscillation tactile sense to a camera operator who is holding the image-capturing apparatus 1.

Feedback on information related to the image-capturing apparatus 1, such as operation information regarding an operation of the image-capturing apparatus 1, reminder information, operation information regarding an operation of an attachment device 8, and image-capturing information acquired by the image-capturing apparatus 1, is given to a camera operator in the form of an oscillation tactile sense provided using the oscillation device 51.

A camera operator can grasp information related to the image-capturing apparatus 1 by a tactile sense being provided by oscillation.

The details will be described later.

Further, in addition to the lens unit 81, various attachment devices may be removably attached to the camera body 2.

<Schematic Overall Configuration of Image-Capturing Apparatus>

As illustrated in FIG. 2, the image-capturing apparatus 1 includes the camera body 2 and the attachment device 8.

[Attachment Device]

The attachment device 8 is a device that is removable from the camera body 2.

Examples of the attachment device 8 include the lens unit 81, a leg 82 such as a tripod, a gimbal 83, an external flash 84, a monitor 85, and a high-sensitivity microphone 86. At least two of these attachment devices 8 can be used as necessary.

Each attachment device 8 includes a communication section that can communicate with a communication section 6 (described later) of the camera body 2.

[Camera Body]

The camera body 2 includes an input-related device 3, a controller 4, an output-related device 5, the communication section 6, a storage 7, the mode dial 38, the shutter button 39, a battery 74, a monitoring section 75, an attachment-device database (hereinafter referred to as an attachment-device DB) 71, an environment-information database (hereinafter referred to as an environment-information DB) 72, and a section 73 for information regarding a user attribute and camera specifications.

(Input-Related Device)

The input-related device 3 includes, for example, an imaging device 31, an acceleration sensor 32, a gyroscope 33, the touch sensor 34, a pressure sensor 35, an infrared sensor 36, and a microphone 37.

The imaging device 31 includes a plurality of light-receiving elements used to perform image-capturing. The imaging device 31 includes a complementary-metal-oxide semiconductor (CMOS) sensor or a charge coupled device (CCD). The imaging device 31 captures an image of a subject. Further, surrounding information regarding surroundings of the image-capturing apparatus 1, that is, image-capturing-environment information can be acquired using image-capturing information acquired by the imaging device 31.

The image-capturing information (captured-image data) acquired by the imaging device 31 is transmitted to the controller 4.

The acceleration sensor 32 is arranged by being secured to an interior of the camera body 2, and detects acceleration that occurs in the image-capturing apparatus 1. The gyroscope 33 is arranged by being secured to the interior of the camera body 2, and detects angular velocity that occurs in the image-capturing apparatus 1. Oscillation information regarding oscillation of the image-capturing apparatus 1 can be detected using a result of sensing performed by the gyroscope 33. Accordingly, the oscillation information regarding oscillation of the image-capturing apparatus 1, such as how the image-capturing apparatus 1 oscillates by a shake induced by the hand of a camera operator, or by oscillation of the oscillation device. Further, a distribution of acceleration occurring in the image-capturing apparatus 1 can be calculated using a result of sensing performed by the acceleration sensor 32 to estimate a state in which a camera operator is holding the image-capturing apparatus 1.

An inertial measurement unit (IMU) that includes an acceleration sensor and a gyroscope may be used.

Acceleration information (acceleration data) and angular-velocity information (angular-velocity data) that are respectively acquired by the acceleration sensor 32 and the gyroscope 33 are transmitted to the controller 4.

Further, results of sensing performed by the acceleration sensor 32 and the gyroscope 33 may be reflected in generation of an output waveform of next oscillation. For example, the controller 4 may determine, from the sensing results, that it is difficult for oscillation to be transmitted to a camera operator due to a strong holding force of the camera operator, and may control oscillation such that next oscillation is made stronger. As described above, feedback on a result of sensing performed by a sensor may be given for a next oscillation waveform.

The touch sensor 34 is a sensor that enables touch operation performed on the display 53. The touch sensor 34 receives an input operation performed by a camera operator. Input-operation information detected by the touch sensor 34 is transmitted to the controller 4.

The pressure sensor 35 detects, for example, a holding force of a camera operator. A detected pressure value is transmitted to the controller 4. A degree of strength of a force with which a camera operator is holding the image-capturing apparatus 1 can be grasped using a result of sensing performed by the pressure sensor 35. Holding-state information regarding a state of holding performed by a camera operator that is acquired using a result of sensing performed by the information pressure sensor 35 may be reflected in generation of an output waveform of next oscillation.

The infrared sensor 36 is arranged near the electronic viewfinder 22. The infrared sensor 36 detects whether eyes of a camera operator are situated close to the electronic viewfinder 22. A result of the detection performed by the infrared sensor 36 is transmitted to the controller 4. Use information regarding use of the electronic viewfinder 22 that is performed by a camera operator can be acquired from the result of the detection performed by the infrared sensor 36. The use information is image-capturing-environment information.

The microphone 37 collects sound in the surroundings. Data of the collected sound is transmitted to the controller 4. The image-capturing-environment information regarding an environment of image-capturing performed by (surrounding information regarding surroundings of) the image-capturing apparatus 1 can be acquired from the data of the sound collected by the microphone 37.

(Battery and Monitoring Section)

The battery 74 is a drive power supply used to drive the image-capturing apparatus 1, and is, for example, four AA dry-cell batteries. The battery 74 is accommodated in, for example, a battery accommodation room situated in an interior of the grip portion 21 of the camera body 2.

The monitoring section 75 monitors a remaining life of the battery 74 and power consumption of the camera body 2. Information obtained by the monitoring section 75 is output to the controller 4.

(Controller)

The controller 4 is supplied with electric power by the battery 74. The controller 4 controls an operation of the overall image-capturing apparatus 1.

The controller 4 controls oscillation of the oscillation device 51 on the basis of at least one of image-capturing-environment information regarding an environment of image-capturing performed by the image-capturing apparatus 1, image-capturing-setting information set by a camera operator, or state information regarding a state of the image-capturing apparatus 1. This control performed on oscillation includes not only adjustment of an oscillation waveform but also control of not providing oscillation.

The controller 4 acquires image-capturing-environment information on the basis of a result of sensing performed by the input-related device 3. For example, the controller 4 obtains image-capturing-environment information such as information indicating that an image-capturing location is a snow-covered mountain or a city, information indicating that image-capturing is performed at a quiet place or a noisy place, and use information regarding use of the electronic viewfinder 22 that is performed by a camera operator.

The controller 4 acquires input-operation information regarding an input operation performed by a camera operator using, for example, the display 53 on which a touch operation can be performed or the mode dial 38, and acquires image-capturing-setting information.

The state information regarding a state of the image-capturing apparatus includes at least one of type information regarding the type of the attachment device 8 attached to the camera body 2, form information regarding the form of the attachment device 8, holding-state information regarding a state in which a camera operator is holding the image-capturing apparatus 1, or remaining-life information regarding a remaining life of the battery 74 serving as a drive power supply used to drive the image-capturing apparatus 1. A specific example of controlling oscillation according to the state information regarding a state of the image-capturing apparatus will be described later.

The controller 4 may generate a sound signal used to drive a speaker 52 such that at least one of the operation information regarding an operation of the image-capturing apparatus 1, the reminder information, the operation information regarding an operation of the attachment device, or the image-capturing information acquired by the image-capturing apparatus 1 is provided using sound.

The controller 4 may acquire information regarding a remaining life of the battery 74 and power consumption of the camera body 2 from the monitoring section 75, and may control oscillation of the oscillation device 51 on the basis of the acquired information.

(Output-Related Device)

The output-related device 5 includes, for example, the oscillation device 51, the speaker 52, and the display 53.

The oscillation device 51 is supported by the housing 20 to be arranged in the interior of the housing 20. For example, a linear oscillation actuator or a voice coil motor may be used as the oscillation device 51. This makes it possible to easily provide various tactile senses. An example of using a voice coil motor as the oscillation device 51 is described here.

The voice coil motor (VCM) is an oscillation actuator used to provide a tactile sense, and is a linear oscillation actuator that includes a linearly oscillating oscillator. The linear oscillation actuator can provide various tactile senses by controlling an amplitude and an oscillation frequency of a linearly moving oscillator as appropriate. Note that, in addition to a voice coil motor, an actuator that can provide a tactile sense using pressure, a linear resonant actuator (LRA), an actuator using a piezoelectric element, or the like may be used as the linear oscillation actuator. These linear oscillation actuators are examples of an oscillation device according to the present embodiment.

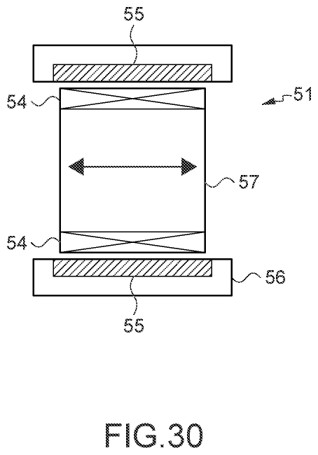

FIG. 30 schematically illustrates an example of a configuration of a voice coil motor used as the oscillation device 51. The oscillation device 51 includes an oscillator 56 and a stator 57. The oscillation device 51 is a linear actuator that generates oscillation by the oscillator 56 reciprocating relative to the stator 57 in a specified direction. A direction in which the oscillator 56 moves (a right-and-left direction in the figure) is referred to as an oscillation direction.

For example, the oscillator 56 has a shape of a column of which a central axis extends in the oscillation direction. An electric wire or the like is wound around a lateral surface of the oscillator 56 to be formed into a coil 54. The stator 57 is arranged by being secured to the housing 20, and includes a cylindrical space that accommodates therein the oscillator 56 such that the oscillator 56 can move in the oscillation direction. A magnet 55 is arranged on an inner surface of the cylindrical space such that one of the magnetic poles (the south pole or the north pole) of the magnet 55 is oriented toward the oscillator 56. Further, the oscillator 56 and the stator 57 are connected to each other through an elastic body such as a spring (not illustrated).

For example, the oscillator 56 reciprocates in the oscillation direction by an AC current flowing through the coil 54 of the oscillator 56. A reaction generated by the reciprocation acts on the housing 20 of the camera body 2, and the camera body 2 itself oscillates. This makes it possible to provide, using oscillation, a tactile sense to a camera operator who is grasping the grip portion 21 of the camera body 2.

The oscillation device (the voice coil motor) 51 is driven by, for example, voltage drive. For example, a voltage signal (hereinafter referred to as a drive signal) used to drive the oscillation device 51 is applied to the coil 54 from the battery 74 serving as a drive source. This drive signal is generated by the controller 4.

The oscillation device (the voice coil motor) 51 can generate oscillation at any amplitude over a wide range of frequencies by controlling, for example, a width and a cycle of reciprocation of the oscillator 56. Thus, the voice coil motor can also be a wide-frequency-range actuator that generates wide-frequency-range oscillation. This makes it possible to significantly improve the tactile-sense (haptic) expressiveness.

A specific configuration of the oscillation device (the voice coil motor) 51 is not limited. For example, a moving-magnet motor in which the magnet 55 is arranged in the oscillator 56 may be used instead of the moving-coil motor in which the coil 54 is formed on the oscillator 56, as illustrated in FIG. 30. Further, for example, a configuration in which the stator 57 is provided to an interior of the oscillator 56 may be adopted. Moreover, a size, a shape, and the like of the voice coil motor may be set as appropriate according to, for example, a size of the camera body 2 including the voice coil motor.

The speaker 52 outputs sound on the basis of a sound signal generated by the controller 4. For example, a speaker (a piezoelectric speaker) using a piezoelectric element may be used.

As described above, the display 53 can display thereon, for example, a through-the-lens image, a captured image, a reconstructed image, and a shooting mode setting screen.

(Communication Section)

The communication section 6 communicates with an apparatus, such as the attachment device 8, that is different from the camera body 2, and can transmit and receive various information.

(Storage)

The storage 7 stores therein data necessary for processing performed by the camera body 2 serving as an information processing apparatus. For example, the storage 7 stores therein digital data (captured-image data) of an image captured by the imaging device. Further, the storage 7 stores therein, for example, a program that is related to control on oscillation of the oscillation device and provides a function of the controller 4 by being executed by a central processing unit (CPU). The storage 7 is implemented by a storage apparatus such as a read only memory (ROM) and a random access memory (RAM), and a removable storage medium such as an optical disk, a magnetic disk, and a semiconductor memory being used in combination as necessary. Thus, the program described above may be downloaded from a network (not illustrated) to be stored in a storage apparatus, or may be stored in a removable storage medium in advance.

(Attachment-Device DB, Environment-Information DB, Section for Information Regarding User Attribute and Specifications of Camera Body)

The attachment-device DB 71 stores therein attachment-device-related information such as a weight of the attachment device 8.

The environment-information DB 72 stores therein information in which environment information regarding an environment estimated from a result of sensing performed by the input-related device 3 is associated with a drive signal for (a waveform of oscillation of) the oscillation device that is suitable for the environment.

The section 73 for information regarding a user attribute and camera specifications stores therein user-attribute information and information regarding specifications of a camera body. The user-attribute information is information such as an age and a gender of a camera operator. In general, the sensitivity differs depending on age and gender. Thus, a minor adjustment of, for example, a degree of strength of oscillation of the oscillation device can be made using the user-attribute information.

<Configuration of Image-Capturing Apparatus Including Lens Unit>

Next, a configuration of the image-capturing apparatus 1 in which the lens unit 81 is attached to the camera body 2 is described with reference to FIG. 3. A configuration of the lens unit 81, and an internal configuration of the camera body 2 that is not described above are primarily described. In FIG. 3, primary structural elements of the internal configuration of the camera body 2 are described, and illustrations of the mode dial 38, the shutter button 39, the attachment-device DB 71, the environment-information DB 72, the section 73 for information regarding a user attribute and camera specifications, the battery 74, the monitoring section 75, the input-related device except for the imaging device 31, and the output-related device except for the oscillation device 51 are omitted.

[Configuration of Lens Unit]

An internal configuration of the lens unit 81 is described.

As illustrated in FIG. 3, the lens unit 81 includes a shooting lens 814, a lens controller 811, a lens driving section 812, a stop driving section 813, a stop 815, a zoom driving mechanism 816, a zoom position detector 817, and a communication section 810.

Examples of a lens unit include a monofocal-lens unit in which a focal length is fixed and zooming is not performed, and a zoom-lens unit in which zooming is performed. An example of using a zoom lens is described when the lens unit is described below.

The shooting lens 814 can be moved in an optical-axis direction. In the example illustrated in FIG. 3, the shooting lens 814 is illustrated in the form of a single lens. However, the shooting lens 814 actually includes a plurality of lens such as a focus lens and a zoom lens.

The lens controller 811 controls driving of the shooting lens 814 through the lens driving section 812, and drives the stop 815 through the stop driving section 813 to control the stop according to the brightness of a subject upon shooting operation.

Further, a zoom lens can be moved by, for example, a camera operator operating the zoom driving mechanism 816 manually. A position of the moved zoom lens (a focal length) is detected by the zoom position detector 817, and detected position is transmitted to the lens controller 811.

As illustrated in FIG. 3, the communication section 810 of the lens unit 81 is connected to the communication section 6 included in the camera body 2 through a communication point A of connection between the lens unit 81 and the camera body 2. This enables the lens unit 81 and the camera body 2 to communicate information.

The connection through the communication connection point A enables the lens controller 811 to notify, through the communication sections 810 and 6, the controller 4 of the type of the lens unit 81 and zoom information such as a focal length and a focus position.

Further, the attachment device other than the lens unit also includes a communication section, and is connected to the camera body through a communication connection point. This enables the attachment device other than the lens unit and the camera body to communicate information. Furthermore, the connection through a communication connection point enables the controller 4 of the camera body 2 to acquire the type of an attachment device attached to the camera body 2, and operation information regarding an operation of the attachment device. The operation information regarding an operation of an attachment device is, for example, charge-completion information regarding completion of charging of an external flash attached to the camera body, and input-operation information regarding an input operation performed on the monitor attached to the camera body.

The connection between the camera body and an attachment device through a communication connection point may be hereinafter referred to as an “electrical connection”.

[Configuration of Camera Body]

As illustrated in FIG. 3, the camera body 2 includes the communication section 6, a mechanical shutter 11, the imaging device 31, the controller 4, and the oscillation device 51.

When the image-capturing apparatus 1 is in a non-shooting state, a light beam of a subject passes through the shooting lens 814 and the stop 815 of the lens unit 81 to be headed for the imaging device 31 including a CMOS sensor or a CCD. While each pixel of the imaging device 31 is being exposed to light, the pixel photoelectrically converts, according to a light amount, an optical image of the subject that is formed by the lens unit 81, and accumulates obtained charge. The accumulated charge is transmitted to a signal processor (not illustrated) of the camera body 2, and captured-image data generated by the signal processor in real time is displayed on the electronic viewfinder 22 and the display 53. This enables a camera operator to view a subject image through the electronic viewfinder 22 or the display 53.

A focal-plane shutter (hereinafter referred to as a mechanical shutter) 11 is arranged on an object side (a lens side) relative to the imaging device 31. The mechanical shutter 11 includes a front shutter curtain (hereinafter referred to as a mechanical front shutter curtain) that includes a plurality of light-shielding blades, and a rear shutter curtain (hereinafter referred to as a mechanical rear shutter curtain) that includes a plurality of light-shielding blades.

In the present embodiment, an image-capturing apparatus that includes a mechanical shutter mechanism that performs a shooting operation using the mechanical front shutter curtain and the mechanical rear shutter curtain that are included in the mechanical shutter 11 is described as an example. However, the present technology is not limited thereto. The present technology can also be applied to an image-capturing apparatus that includes a hybrid shutter mechanism including an electronic front shutter curtain operated by the imaging device and a mechanical rear shutter curtain, and an image-capturing apparatus that includes an electronic shutter mechanism including an electronic front shutter curtain and an electronic rear shutter curtain that are operated by the imaging device. Further, all of the mechanical shutter mechanism, the electronic shutter mechanism, and the hybrid shutter mechanism may be used in a single image-capturing apparatus. The hybrid shutter mechanism and the electronic shutter mechanism will be described later.

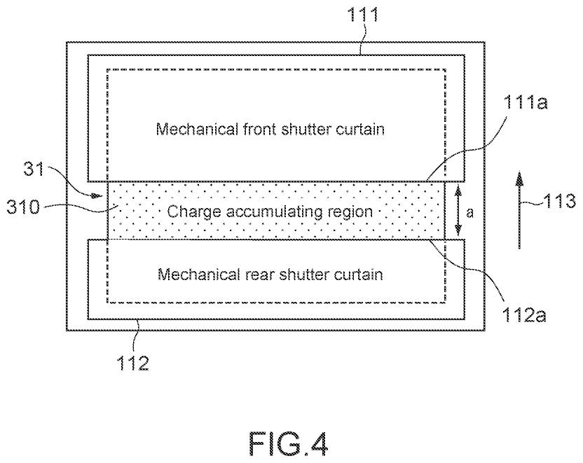

FIG. 4 is a front view of the imaging device 31, a mechanical front shutter curtain 111, and a mechanical rear shutter curtain 112, as viewed from a lens side in the optical-axis direction. In FIG. 4, the mechanical front shutter curtain 111 and the mechanical rear shutter curtain 112 of the mechanical shutter 11 shield a portion of a region of the imaging device 31 from light.

As illustrated in FIG. 4, the mechanical shutter mechanism includes a front shutter curtain and a rear shutter curtain that are included in the mechanical shutter 11. The mechanical front shutter curtain 111 covering the imaging device 31 is moved to allow light to be incident on the imaging device 31, and then the mechanical rear shutter curtain 112 is moved to interrupt the incidence of light on the imaging device 31. This results in a shooting operation (a mechanical-shutter operation) being performed by the mechanical shutter.

As illustrated in FIG. 4, a charge accumulating region 310 is a region that is formed of a slit situated between an end 111a of the mechanical front shutter curtain 111 and an end 112a of the mechanical rear shutter curtain 112 is not shielded from light by the mechanical front shutter curtain 111 and the mechanical rear shutter curtain 112, the region being a region, in the imaging device 31, in which charge is accumulated by exposure. In response to the movement of the mechanical front shutter curtain 111 and the mechanical rear shutter curtain 112, the charge accumulating region 310 is moved in a direction of an arrow 113. The period of time from the end 111a of the mechanical front shutter curtain 111 passing through, that is, from light being allowed to be incident on the imaging device 31 to the mechanical rear shutter curtain 112 shielding the imaging device 31 from the light is a period of time for which charge is accumulated by the pixel being exposed to the light. Thus, the adjustment of a width (a) of the slit makes it possible to change the charge accumulating region 310 and to adjust an exposure period of time.

<Description of Operation of Image-Capturing Apparatus>

In the present technology, the oscillation device 51 is included in the camera body 2, and feedback on information related to the image-capturing apparatus is given to a camera operator in the form of an oscillation tactile sense provided using the oscillation device.

The information related to the image-capturing apparatus includes at least one of operation information regarding an operation of the image-capturing apparatus 1, reminder information, operation information regarding an operation of the attachment device 8, or image-capturing information acquired by the image-capturing apparatus 1. Feedback on information related to the image-capturing apparatus is given to a camera operator in the form of an oscillation tactile sense provided using the oscillation device 51, and this enables the camera operator to intuitively understand the information related to the image-capturing apparatus.

[Example of Providing Oscillation Indicating Operation Information Regarding Operation of Image-Capturing Apparatus]

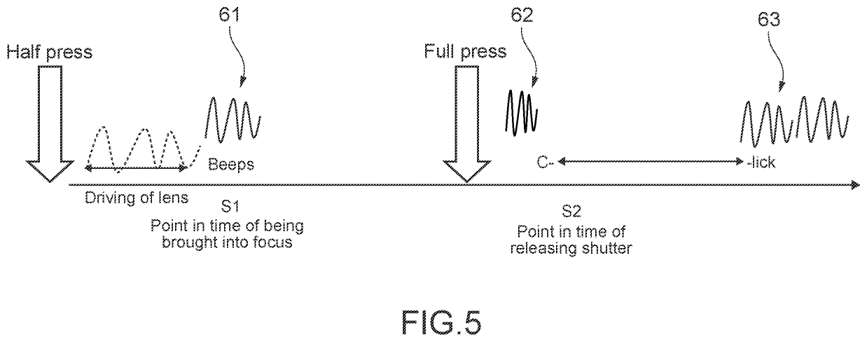

An example of providing operation information regarding an operation of the image-capturing apparatus 1 using an oscillation tactile sense is described with reference to FIG. 5.

The operation information regarding an operation of the image-capturing apparatus includes information regarding a state in which a subject is in focus, information regarding start of exposure performed on the imaging device, and information regarding completion of the exposure performed on the imaging device.

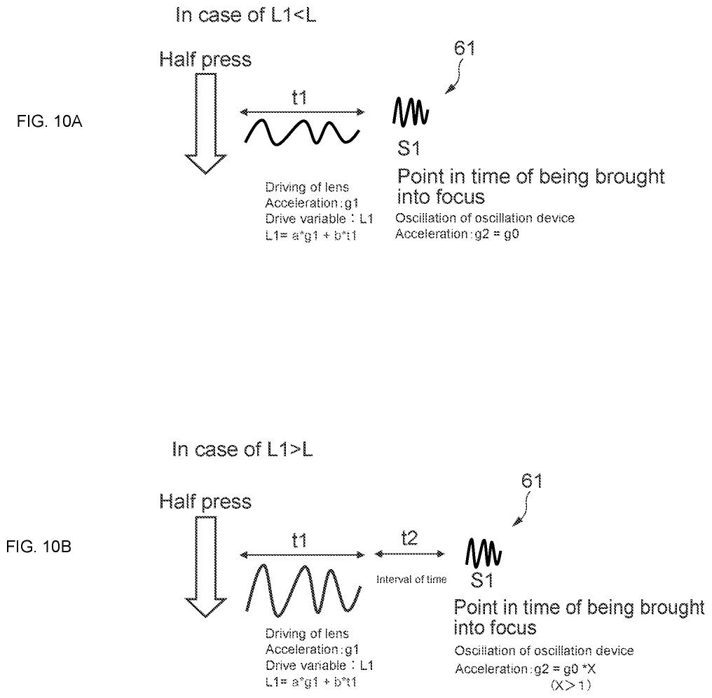

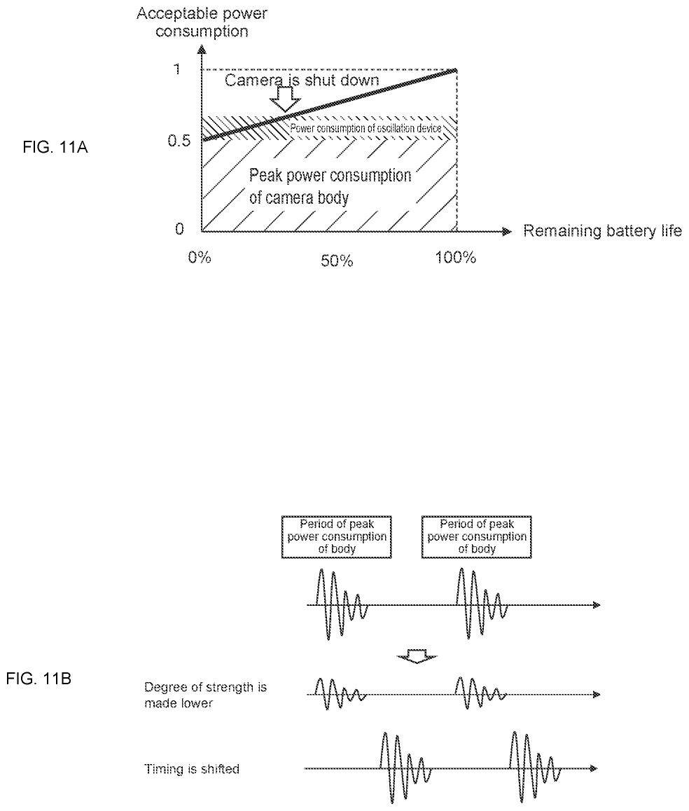

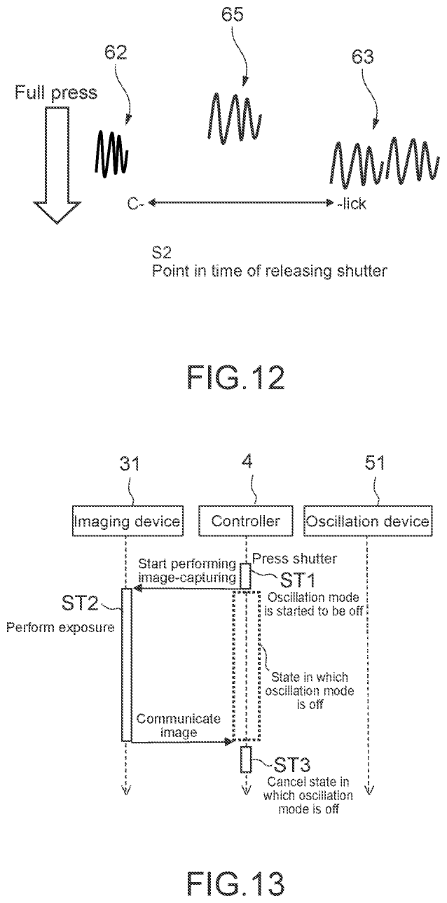

FIG. 5 illustrates an example of providing a camera operator with operation information regarding an operation of the image-capturing apparatus 1 using sound and oscillation. In FIG. 5, and FIGS. 10 and 12 described later, S1 represents a point in time of being brought into focus, and S2 represents a point in time of releasing a shutter.

As described above, when the shutter button 39 is in the half press state, a preparation operation for capturing an image of a subject is performed. The shooting lens 814 is moved in the lens unit 81 to bring the subject into focus. In the example illustrated in FIG. 5, feedback on information indicating that a subject has been brought into focus (hereinafter referred to as completion of being brought into focus) is given to a camera operator together with sound “beeps”, using oscillation 61 of the oscillation device 51. The completion of being brought into focus represents a state in which a subject is in focus.

When the shutter button 39 is in the full press state, a shooting operation is performed. In the example illustrated in FIG. 5, feedback on start of shooting, that is, start of exposure performed on the imaging device 31 is given to a camera operator together with a sound “C-”, using oscillation 62 of the oscillation device 51. The oscillation 62 indicates start of movement of the mechanical front shutter curtain 111.

Further, feedback on completion of shooting, that is, completion of the exposure performed on the imaging device 31 is given to the camera operator together with a sound “-lick”, using oscillation 63 of the oscillation device 51. The oscillation 63 indicates completion of movement of the mechanical rear shutter curtain 112.

As described above, operation information regarding an operation of the image-capturing apparatus 1 is provided by oscillation, and this enables a camera operator to intuitively understand an operation of the image-capturing apparatus 1.

Further, when the image-capturing environment is an environment in which the image-capturing apparatus 1 is not allowed to produce sound, the sound mode can be set to off. The operation of the image-capturing apparatus 1 can also be provided to a camera operator using oscillation when the provision using sound is not allowed, as described above.

When the oscillation 61 indicating completion of being brought into focus, the oscillation 62 indicating start of exposure, and the oscillation 63 indicating completion of the exposure are provided such that a camera operator perceives that those are different kinds of oscillation, this enables the camera operator to precisely understand a state of the image-capturing apparatus.

The oscillation 61, the oscillation 62, and the oscillation 63 may have different oscillation waveforms. This enables a camera operator to distinguish pieces of operation information regarding different operations of the image-capturing apparatus 1 and to understand the state of the image-capturing apparatus more precisely.

Further, at least two of the oscillation waveforms of the oscillation 61, the oscillation 62, and the oscillation 63 may be the same. For example, in the present embodiment, the oscillation 61 is generated after the shutter button 39 is half-pressed, and the oscillation 62 and oscillation 63 are generated after the shutter button 39 is fully pressed. Thus, a camera operator intuitively understands whether oscillation generated following a flow of an operation performed by the camera operator is generated at a point in time of being brought into focus or at a point in time of releasing a shutter. Therefore, the oscillation waveforms may be the same.

Feedback on oscillation indicating reminder information, oscillation indicating operation information regarding an operation of the attachment device 8, and oscillation indicating image-capturing information acquired by the image-capturing apparatus 1 will be described later.

<Specific Example of Controlling Oscillation>

Control performed by the controller 4 on oscillation indicating operation information regarding an operation of the image-capturing apparatus is primarily described as an example. Examples of controlling oscillation described below are also applied to controlling oscillation indicating reminder information described later, oscillation indicating operation information regarding an operation of the attachment device 8 that is described later, and oscillation indicating image-capturing information acquired by the image-capturing apparatus 1 and described later.

The examples of controlling oscillation described below may each be used alone, or two or more thereof may be used in combination.

This makes it possible to appropriately provide information related to the image-capturing apparatus to a camera operator using oscillation of the oscillation device 51 included in the camera body 2, the information related to the image-capturing apparatus including operation information regarding an operation of the image-capturing apparatus 1, reminder information, operation information regarding an operation of the attachment device 8, and image-capturing information. In other words, feedback on the information related to the image-capturing apparatus is given to a camera operator in the form of an oscillation tactile sense such that the camera operator can perceive what information is indicated by each kind of oscillation.

[Example of Controlling Oscillation in Order to Prevent Joining]

There is a possibility that the oscillation 62 indicating start of exposure and the oscillation 63 indicating completion of exposure will be successive depending on a shutter speed (a length of exposure period of time) or a frame rate and thus it will be difficult for a camera operator to perceive the oscillation 62 and the oscillation 63 in a state of distinguishing them. Herein, regarding such two kinds of oscillation that are first oscillation and second oscillation that respectively indicate different pieces of information related to the image-capturing apparatus, processing of making the two kinds of oscillation intermittent such that the two kinds of oscillation are not perceived as being continuous oscillation, is referred to as joining preventing processing. The joining preventing processing enables a camera operator to perceive the first oscillation and the second oscillation in a state of distinguishing them. This makes it possible to appropriately determine what information is indicated by provided oscillation.

Here, the joining preventing processing is described, with two kinds of oscillation that respectively indicate different operations of the image-capturing apparatus 1, that is, start of exposure and completion of exposure being used as examples. However, the present technology is not limited thereto. The joining preventing processing can be applied to preventing two kinds of oscillation that respectively indicate two different pieces of information from being joined. For example, the two kinds of oscillation respectively indicating two pieces of information may be oscillation indicating an operation of the image-capturing apparatus and oscillation indicating reminders, or may be oscillation indicating an operation of the image-capturing apparatus and oscillation indicating an operation of the attachment device, or may be oscillation indicating an operation of the image-capturing apparatus and oscillation indicating image-capturing information. Further, the two kinds of oscillation respectively indicating two pieces of information may be oscillation indicating reminders and oscillation indicating an operation of the attachment device, or may be oscillation indicating reminders and oscillation indicating image-capturing information, or may be oscillation indicating an operation of the attachment device and oscillation indicating image-capturing information. Furthermore, the two kinds of oscillation respectively indicating two pieces of information may each be oscillation indicating reminders, or may each be oscillation indicating an operation of the attachment device.

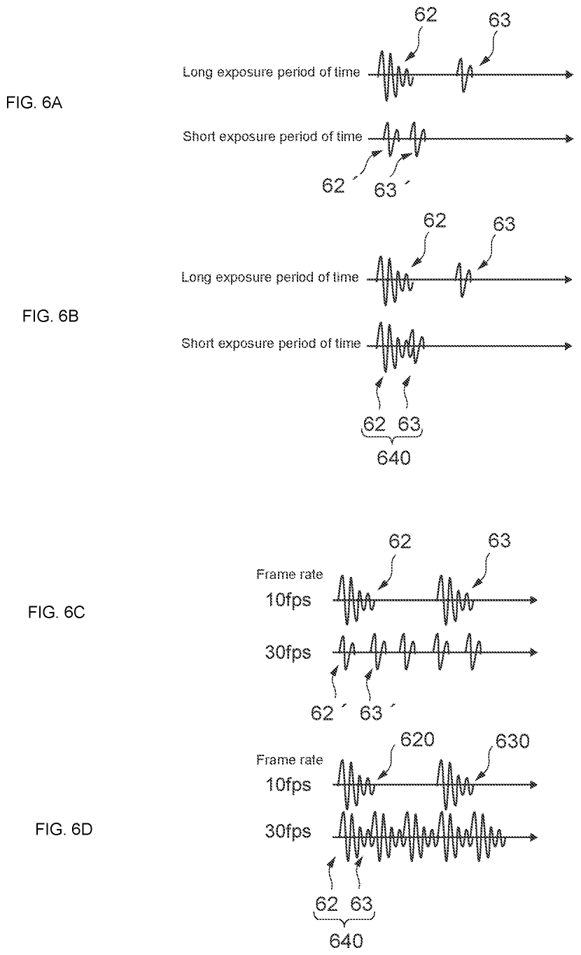

(A) and (C) of FIG. 6 illustrate examples of waveforms of oscillation of the oscillation device 51 in the present embodiment, and (B) and (D) of FIG. 6 illustrate examples of waveforms of oscillation of the oscillation device 51 in a comparative example. An axis that extends laterally represents a temporal axis in each diagram.

When an exposure period of time is relatively long in the comparative example, as illustrated in (B) of FIG. 6, the oscillation 62 indicating start of exposure and the oscillation 63 indicating completion of exposure are made intermittent, and this enables a camera operator to perceive the oscillation 62 and the oscillation 63 in a state of distinguishing them. On the other hand, when the exposure period of time is relatively short and when two kinds of oscillation are generated with oscillation waveforms similar to the oscillation waveforms obtained for the long exposure period of time, the oscillation 62 indicating start of exposure and the oscillation 63 indicating completion of exposure become continuous oscillation 640. This prevents the camera operator from perceiving the oscillation 62 and the oscillation 63 in a state of distinguishing them.

On the other hand, the present embodiment makes it possible to change the oscillation waveform according to the exposure period of time.

When an exposure period of time is long, as illustrated in (A) of FIG. 6, the oscillation 62 indicating start of exposure and the oscillation 63 indicating completion of exposure are generated such that the oscillation 62 and the oscillation 63 have intermittent oscillation waveforms, in order to cause a camera operator to perceive that the oscillation 62 and the oscillation 63 are different kinds of oscillation.

On the other hand, when the exposure period of time is short, oscillation 62′ indicating start of exposure and oscillation 63′ indicating completion of exposure are generated with oscillation waveforms that are different from the oscillation waveforms obtained for a long exposure period of time such as oscillation waveforms obtained for a shorter drive period of time. This results in controlling each of the oscillation 62′ and the oscillation 63′ such that the oscillation 62′ and the oscillation 63′ have intermittent oscillation waveforms. This enables a camera operator to perceive that the oscillation 62′ indicating start of exposure and the oscillation 63′ indicating completion of exposure are different kinds of oscillation.

As described above, the oscillation device is controlled such that an oscillation waveform differs depending on an exposure period of time, and this enables a camera operator to perceive the oscillation 62′ and the oscillation 63′ in a state of distinguishing them.

When a frame rate exhibits a relatively small value in the comparative example, as illustrated in (D) of FIG. 6, the oscillation 62 indicating start of exposure and the oscillation 63 indicating completion of exposure are made intermittent, and this enables a camera operator to perceive the oscillation 62 and the oscillation 63 in a state of distinguishing them. On the other hand, when the frame rate exhibits a relatively large value and when two kinds of oscillation are generated with oscillation waveforms similar to the oscillation waveforms obtained with the small value of the frame rate, the oscillation 62 indicating start of exposure and the oscillation 63 indicating completion of exposure become the continuous oscillation 640. This prevents the camera operator from perceiving the oscillation 62 and the oscillation 63 in a state of distinguishing them.

On the other hand, the present embodiment makes it possible to change the oscillation waveform according to the value of the frame rate.

When a frame rate exhibits a relatively small value in the present embodiment, as illustrated in (C) of FIG. 6, the oscillation 62 indicating start of exposure and the oscillation 63 indicating completion of exposure are generated such that the oscillation 62 and the oscillation 63 have intermittent oscillation waveforms, in order to cause a camera operator to perceive that the oscillation 62 and the oscillation 63 are different kinds of oscillation.

When the frame rate exhibits a relatively large value, two kinds of oscillation are generated with oscillation waveforms that are different from the oscillation waveforms obtained with the small value of the frame rate such as oscillation waveforms obtained for a shorter drive period of time. This results in controlling each of the oscillation 62′ and the oscillation 63′ such that the oscillation 62′ and the oscillation 63′ have intermittent oscillation waveforms. This enables a camera operator to perceive that the oscillation 62′ indicating start of exposure and the oscillation 63′ indicating completion of exposure are different kinds of oscillation.

As described above, the oscillation device is controlled such that an oscillation waveform differs depending on a frame rate, and this enables a camera operator to perceive the oscillation 62′ and the oscillation 63′ in a state of distinguishing them.

A camera operator can perceive two kinds of oscillation in a state of distinguishing them by an oscillation waveform representing start of exposure and an oscillation waveform representing completion of exposure being controlled on the basis of at least one of a shutter speed or frame rate that is set by the camera operator, that is, on the basis of image-capturing-setting information.

The following three cases in which the two different kinds of oscillation described above are perceived as being as continuous oscillation are conceivable. Two kinds of oscillation are joined to each other due to at least one of these three cases.

In the following description, an interval of time between one oscillation and other oscillation upon performing input is represented by Ti. An interval of time between one oscillation and other oscillation upon performing output is represented by To.

The first case is a case in which, when a drive signal used to drive the oscillation device 51 is input to the oscillation device 51, waveforms overlap to become a continuous waveform, as illustrated in each of lower portions of (B) and (D) of FIG. 6. Ti<0 in this case.

Such a case in which two oscillation waveforms overlap to become a continuous oscillation waveform upon performing input is estimated in advance from image-capturing-setting information that is set by a camera operator. Examples of the image-capturing-setting information include whether the mode is a single-shooting mode or a consecutive-shooting mode, a shutter speed, and a frame rate upon consecutive shooting. The joining preventing processing may be performed on the basis of image-capturing-setting information set by a camera operator, as described above.

Further, information regarding an oscillation waveform may be provided in advance such that a camera operator can perceive two different kinds of oscillation (oscillation indicating start of exposure and oscillation indicating completion of exposure in this example) in a state of distinguishing them for each shutter speed or for each frame rate.

The second case is a case in which waveforms are intermittent waveforms without overlapping when a drive signal is input to the oscillation device but the waveforms overlap to become a continuous waveform when the drive signal is output from the oscillation device. To<0 in this case.

A difference between Ti and To is changed according to characteristics of the oscillation device or the frequency to be used. The difference between Ti and To can be acquired in advance using a combination of an oscillation device and the camera body 2 including the oscillation device. Further, a weight and a center of gravity of the entirety of the image-capturing apparatus differ depending on the type of an attachment device attached to the camera body 2, the number of the attachment devices, or the form of the attachment device. The difference between Ti and To can be acquired in advance for each type of an attachment device to be attached, for each number of the attachment devices, and for each form of the attachment device. The joining preventing processing may be performed using the difference between Ti and To that is acquired in advance.

As described above, the joining preventing processing may be performed on the basis of state information regarding a state of the image-capturing apparatus.

Note that there is a possibility that the difference between Ti and To will be changed in real time according to, for example, a way in which the image-capturing apparatus 1 is held by a camera operator, or how strongly the image-capturing apparatus 1 is held by the camera operator. In this case, oscillation information regarding oscillation of the image-capturing apparatus may be acquired using results of sensing performed by, for example, the pressure sensor 35, the acceleration sensor 32, and the gyroscope 33, the difference between Ti and To may be corrected for using the oscillation information, and the correction may be reflected in generation of an output waveform of next oscillation.

The third case is a case in which, due to limits of a human performance in temporal two-point discrimination, a camera operator perceives, even when To>0, that two kinds of oscillation have waveforms that overlap to become a continuous waveform.

The human performance in temporal two-point discrimination is roughly from 10 ms to 50 ms, which depends on conditions. For example, an interval of time between two kinds of oscillation is adjusted to control the two kinds of oscillation such that To>Th, where Th represents a threshold for the human performance in temporal two-point discrimination. This makes it possible to cause a camera operator to perceive that the two kinds of oscillation generated at different points in time are intermittent two kinds of oscillation.

Further, To<0 may be satisfied due to the oscillation device 51 being started slowly. Since the characteristics of the oscillation device 51 can be grasped in advance, information regarding an oscillation waveform may be provided in advance on the basis of the characteristics of the oscillation device 51, such that a camera operator can perceive two different kinds of oscillation as intermittent two kinds of oscillation.

Examples of the joining preventing processing that cause two different kinds of oscillation to be less likely to be perceived as being continuous oscillation are described below. The examples described below may be appropriately used in combination.

With respect to oscillation waveforms input to the oscillation device, the joining preventing processing can be performed by changing, for example, an interval of time between oscillation waveforms, a drive period of time of the oscillation device, a degree of strength of oscillation (amplitude), and the frequency.

A short interval of time results in two different kinds of oscillation being easily perceived as being continuous oscillation. Thus, waveforms are changed to make the interval of time longer, and this results in two different kinds of oscillation being easily perceived as being two different kinds of oscillation.

A long drive period of time results in two different kinds of oscillation being easily perceived as being continuous oscillation. Thus, waveforms are changed to make the interval of time shorter, and this results in two different kinds of oscillation being easily perceived as being two different kinds of oscillation.

A low degree of strength of oscillation results in two different kinds of oscillation being easily perceived as being continuous oscillation. Thus, waveforms are changed to make the degree of strength higher, and this results in two different kinds of oscillation being easily perceived as being two different kinds of oscillation.

The frequency is dependent on sensitivity characteristics of humans. At a frequency of from 200 Hz to 250 Hz, two different kinds of oscillation are easily perceived as being continuous oscillation since a degree of sensitivity is high. Thus, the frequency is set to be out of the range described above, and this results in two different kinds of oscillation being easily perceived as being two different kinds of oscillation.

The joining preventing processing can be performed by changing oscillation waveforms according to the type and the form of the attachment device 8 attached to the camera body 2. The type and the form of the attachment device 8 in the image-capturing apparatus 1 correspond to state information regarding a state of the image-capturing apparatus.

When the attachment device weighs heavy, two different kinds of oscillation are easily perceived as being continuous oscillation. Thus, as described above, for example, the interval of time between oscillation waveforms, the drive period of time of the oscillation device, the degree of strength of oscillation (amplitude), and the frequency are changed according to the weight of the attachment device with respect to oscillation waveforms input to the oscillation device, and this results in two different kinds of oscillation being easily perceived as being two different kinds of oscillation.

Further, different types of attachment devices have different shapes, and a typical way in which the image-capturing apparatus is held differs depending on the type of attachment device. A lens unit is described as an example. When the image-capturing apparatus to which a monofocal-lens unit is attached is held, a camera operator typically holds the camera body with his/her two hands. On the other hand, when the image-capturing apparatus to which a zoom-lens unit is attached is held, a camera operator typically holds to support the zoom-lens unit with his/her left hand and holds the camera body with his/her right hand. As described above, the area of contact of the camera body with the hand of a camera operator differs depending on a holding state for each attachment device. A small contact area results in two different kinds of oscillation being easily perceived as being continuous oscillation. Thus, as described above, for example, the interval of time between oscillation waveforms, the drive period of time of the oscillation device, the degree of strength of oscillation (amplitude), and the frequency are changed according to the type of attachment device with respect to oscillation waveforms input to the oscillation device, and this results in two different kinds of oscillation being easily perceived as being two different kinds of oscillation.

As described above, the joining preventing processing may be performed on the basis of state information regarding a state of the image-capturing apparatus.

The joining preventing processing can be performed by changing oscillation waveforms according to characteristics of the oscillation device 51.

For example, oscillation waveforms can be changed according to frequency-and-acceleration characteristics of the oscillation device. For example, when an input frequency is close to a resonance frequency, oscillation is more likely to still remain after oscillation is generated by the oscillation device being driven. This results in two different kinds of oscillation being easily perceived as being continuous oscillation. Further, the oscillation device is also started slowly. Thus, the input frequency is set to be different from a resonance frequency, and this results in two different kinds of oscillation being easily perceived as being two different kinds of oscillation.

Further, oscillation waveforms can be changed according to temporal responsiveness of the oscillation device. For example, when the oscillation device is started slowly, this results in two different kinds of oscillation being easily perceived as being continuous oscillation. Thus, oscillation waveforms may be changed in consideration of temporal responsiveness of the oscillation device.

Since the above-described characteristics of the oscillation device can be acquired in advance, information regarding an oscillation waveform may be provided in advance on the basis of the characteristics of the oscillation device 51, such that a camera operator can perceive two different kinds of oscillation as intermittent two kinds of oscillation.

The state information regarding a state of the image-capturing apparatus includes information regarding what characteristics the oscillation device 51 included in the camera body 2 has.

As described above, the joining preventing processing may be performed on the basis of state information regarding a state of the image-capturing apparatus.

The joining preventing processing can be performed by changing oscillation waveforms according to information, such as a way in which a camera operator holds the image-capturing apparatus, and an overloaded oscillation device, that can be changed in real time.

For example, when a camera operator holds the camera body 2 strongly, this results in difficulty in generating oscillation, and thus in two different kinds of oscillation being easily perceived as being continuous oscillation. Thus, as described above, for example, the interval of time between oscillation waveforms, the drive period of time of the oscillation device, the degree of strength of oscillation (amplitude), and the frequency are changed according to how strongly a camera operator holds the camera body 2 with respect to oscillation waveforms input to the oscillation device, and this results in two different kinds of oscillation being easily perceived as being two different kinds of oscillation.

Holding information regarding holding of the image-capturing apparatus 1 that is performed by a camera operator, such as a degree of strength of a force with which a camera operator holds the image-capturing apparatus 1 and a way in which the camera operator is holding the image-capturing apparatus 1, can be detected using a result of sensing performed by the input-related device 3 including the acceleration sensor, the gyroscope, and the pressure sensor. The holding information is included in the state information regarding a state of the image-capturing apparatus 1.

For example, when the oscillation device is driven for a long period of time, the oscillation device may get hot and this may result in difficulty in generating oscillation. In this case, two different kinds of oscillation are easily perceived as being continuous oscillation. Thus, as described above, for example, the interval of time between oscillation waveforms, the drive period of time of an oscillation device, the degree of strength of oscillation (amplitude), and the frequency are changed according to a state of the oscillation device with respect to oscillation waveforms input to the oscillation device, and this results in two different kinds of oscillation being easily perceived as being two different kinds of oscillation. Information related to the oscillation device is included in the state information regarding a state of the image-capturing apparatus 1.

As described above, the joining preventing processing may be performed on the basis of state information regarding a state of the image-capturing apparatus.

The example of controlling oscillation by performing joining preventing processing such that different kinds of oscillation respectively indicating different operations of a plurality of different operations of the image-capturing apparatus can be perceived as being intermittent different kinds of oscillation, has been described above. On the other hand, oscillation of the oscillation device may be controlled on the basis of image-capturing-setting information, such that the joining preventing processing is not performed.

For example, when an underwater shooting mode is selected, oscillation of the camera body 2 that is generated by the oscillation device 51 is perceived small by a camera operator upon performing image-capturing under water, compared to when image-capturing is performed on the surface of the earth. Further, when a glove mode is selected, oscillation of the camera body 2 that is generated by the oscillation device 51 is perceived small by a camera operator, compared to when the camera operator performs image-capturing with his/her bare hands.

When the mode for performing image-capturing is set to be the underwater shooting mode or glove mode in which a camera operator is less likely to feel oscillation, the oscillation device may be controlled such that camera operator's perception of oscillation is prioritized to not perform the joining preventing processing described above and such that the strength of oscillation is maximized regardless of whether two different kinds of oscillation are perceived as being continuous oscillation. This enables a camera operator to intuitively understand an operation of the image-capturing apparatus 1 using oscillation even in a state in which the camera operator is less likely to feel oscillation.

As described above, oscillation of the oscillation device 51 may be controlled on the basis of image-capturing-setting information set by a camera operator.

Note that the joining preventing processing performed to cause two kinds of oscillation respectively indicating two different pieces of information to be perceived as being intermittent two kinds of oscillation, has been described here as an example of controlling oscillation in order for a camera operator to perceive pieces of information respectively indicated by different kinds of oscillation in a state of distinguishing them.

On the other hand, oscillation may be controlled such that a camera operator can perceive two kinds of oscillation respectively indicating two different pieces of information in a state of distinguishing them even if the two kinds of oscillation are perceived as being continuous oscillation. For example, degrees of strengths of two kinds of oscillation respectively indicating two different pieces of information can be changed to such an extent that the two kinds of oscillation are perceived as being continuous oscillation by a camera operator but the camera operator can perceive that the two kinds of oscillation are two kinds of oscillation respectively indicating different pieces of information.

[Example of Controlling Oscillation Taking Consideration into Oscillation Due to Mechanical Shutter]

The image-capturing apparatus 1 according to the present embodiment includes a mechanical shutter mechanism. When a mechanical front shutter curtain and a mechanical rear shutter curtain are moved, oscillation due to operations of the mechanical front shutter curtain and the mechanical rear shutter curtain is generated in the camera body 2.

In the present embodiment, the oscillation 62 indicating start of exposure is provided by the oscillation device 51 being driven, as described above. Further, the oscillation 63 indicating completion of exposure is provided by the oscillation device 51 being driven.

In consideration of oscillation due to an operation of the mechanical shutter, the controller 4 may generate simulated-tactile-sense oscillation such that the oscillation 62 and oscillation 63 provided to a camera operator have desired oscillation waveforms.

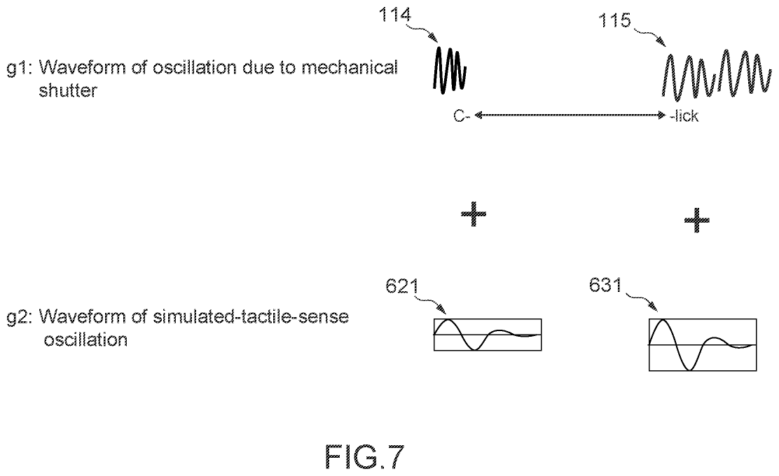

As schematically illustrated in FIG. 7, the controller 4 generates simulated-tactile-sense oscillation 621 that is generated in conformity to a waveform 114 of oscillation due to mechanical shutter so that the oscillation 62 has a desired oscillation waveform. The controller 4 generates simulated-tactile-sense oscillation 631 that is generated in conformity to a waveform 115 of oscillation due to mechanical shutter so that the oscillation 63 has a desired oscillation waveform.

As described above, when an oscillation tactile sense is provided by the image-capturing apparatus including a mechanical shutter mechanism, oscillation waveforms may be generated in consideration of an amount of oscillation due to mechanical shutter.

In the case of a hybrid shutter mechanism including an electronic front shutter curtain and a mechanical rear shutter curtain, oscillation due to an operation of the mechanical rear shutter curtain is generated in the camera body 2 when the mechanical rear shutter curtain is moved. The electronic front shutter curtain is operated by the imaging device 31 performing electronic control. Thus, no oscillation is generated. In the case of the image-capturing apparatus including such a hybrid shutter mechanism, simulated-tactile-sense oscillation may also be generated in consideration of oscillation due to mechanical shutter.

In the case of the image-capturing apparatus including an electronic shutter mechanism, no oscillation due to mechanical shutter is generated. Thus, there is no need to generate simulated-tactile-sense oscillation in consideration of oscillation due to mechanical shutter.

[Example of Controlling Oscillation Taking into Consideration Sounding of Oscillation Device]

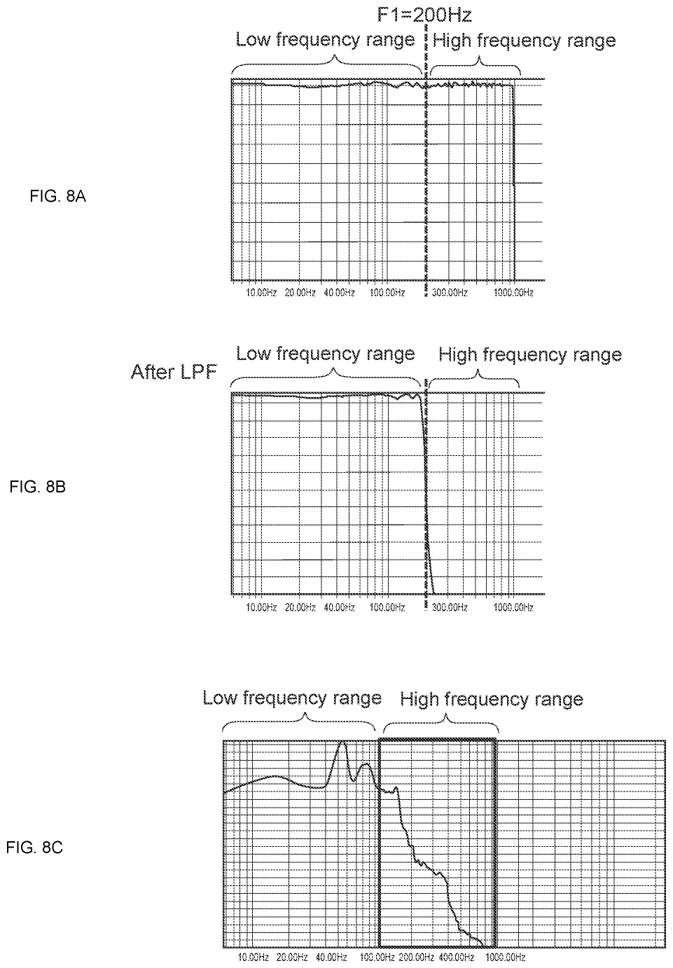

FIG. 8 illustrates, using diagrams, an example of oscillation sound produced by the image-capturing apparatus 1, where a horizontal axis represents frequency and a vertical axis represents a level of sound pressure (decibel).

Various kinds of oscillation can be provided to a camera operator by using an oscillation device that enables acceleration to be obtained over a range covering up to a range of relatively high frequencies. On the other hand, oscillation sound (hereinafter referred to as sounding in some cases) due to the oscillation device 51 is more likely to be produced. Further, a level of sounding differs depending on not only a frequency range but also, for example, a magnitude of sound pressure of a frequency component and a duration time of the sound pressure. For example, there is a reduction in the level of sounding when there are no high-frequency components having a strong spectrum in an audible range of frequencies and the distribution is thin, as illustrated in (C) of FIG. 8.

Oscillation of the oscillation device may be controlled such that such sounding due to oscillation of the oscillation device is adjusted according to image-capturing-environment information or image-capturing-setting information set by a camera operator. The processing performed to prevent such sounding due to oscillation of the oscillation device is herein referred to as sounding preventing processing.

Depending on an image-capturing environment, a camera operator may feel uneasy about oscillation sound produced by the oscillation device 51.

For example, when an image of an animal is captured in a snow-covered mountain, it is favorable that oscillation sound due to the oscillation device 51 not include a frequency component that is clearly audible to animals in order to not let the animal get away. In such a case, the sounding preventing processing including cutting a high-frequency-range component using a low-pass filter, such that sound that is illustrated in (A) of FIG. 8 and includes, in an audible range of frequencies, sound in a range of high frequencies is sound in a range of frequencies that is less than or equal to a frequency threshold F1, as illustrated in (B) of FIG. 8, can be performed.

Further, in a scene in a city, it is sufficient if sounding has a level of magnitude with which the sounding is heard only by a camera operator himself/herself. Thus, the sounding preventing processing including cutting a high-frequency-range component such that sound is in a range of frequencies that is less than or equal to a frequency threshold F2, can be performed.

As described above, oscillation of the oscillation device may be controlled by using, on the basis of image-capturing-environment information, a different frequency threshold used when a low-pass filter is used to perform sounding preventing processing.

The image-capturing-environment information can be calculated using a result of sensing performed by the input-related device 3. More specifically, a scene can be estimated by performing image recognition on a through-the-lens image (captured-image data) that is acquired by the imaging device 31. Further, a scene can be more precisely estimated taking into consideration data of sound such as environmental sound in the surroundings on which sensing is performed using a microphone. Furthermore, environmental sound in the surroundings is acquired using a microphone, and this makes it possible to adjust a range of frequencies in which the oscillation device 51 is used, and sound pressure.

A scene and a frequency threshold used to perform sounding preventing processing that is suitable for the scene may be associated with each other to be stored in a database. Further, the behavior of a camera operator may be learned, and information regarding a combination of a scene and a frequency threshold that are associated with each other, may be automatically generated to update a database. For example, when a camera operator turns off the oscillation mode at all times in a specific scene, information in which the specific scene and a state in which the oscillation mode is off are combined, may be stored in a database.

When the sound mode indicating, for example, an operation of the image-capturing apparatus is set to on by a camera operator, it may be determined that it is not a problem if oscillation sound due to the oscillation device 51 is produced, and the above-described sounding preventing processing including, for example, using a low-pass filter does not have to be performed.

As described above, oscillation of the oscillation device may be controlled on the basis of image-capturing-setting information set by a camera operator, such that sounding preventing processing is not performed.

Further, when sounding preventing processing is performed, sounding preventing processing that can be chronologically changed in consideration of an oscillation signal, may be performed.

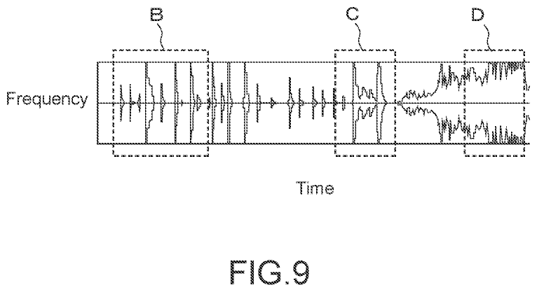

FIG. 9 illustrates a sound waveform of sound of oscillation of the oscillation device. A horizontal axis represents time, and a vertical axis represents frequency.

As illustrated in FIG. 9, for example, very few high-frequency-range components are in a dashed region B. Thus, sounding preventing processing is not performed.

A somewhat large number of high-frequency components are in a region C. In this case, sounding preventing processing including cutting a high-frequency-range component using a low-pass filter that enables moderate cutting, is performed.

A very large number of high-frequency-range components are in a region D. In this case, sounding preventing processing including cutting all of the high-frequency-range components, is performed.

[Example of Controlling Oscillation Taking into Consideration Oscillation Due to Lens Being Driven]

As described above, when the shutter button 39 in the image-capturing apparatus 1 is in the half press state, a preparation operation for capturing an image of a subject is performed, and a lens in a zoom-lens unit is driven to be moved in the optical-axis direction. When the lens is driven, oscillation having a level of strength with which a camera operator can perceive the oscillation may be generated. Control may be performed taking into consideration such oscillation generated by a lens being driven, such that the oscillation 61 indicating the oscillation 61 indicating completion of being brought into focus is easily perceived by a camera operator.

An example of performing output such that the oscillation 61 indicating completion of being brought into focus is oscillation that is easily perceived by a camera operator, is described with reference to FIG. 10.

(A) of FIG. 10 illustrates a basic state in which a lens drive variable L1 is smaller than a drive threshold L.

(B) of FIG. 10 illustrates a state in which the lens drive variable L1 is larger than the drive threshold L.

In the figure, t1 represents a lens driving period of time. t2 represents an interval of time from driving of a lens being finished to the oscillation 61 indicating completion of being brought into focus being generated. g1 represents acceleration of the image-capturing apparatus 1 during driving of a lens, and g2 represents acceleration occurring in the oscillation device 51 at a point in time of being brought into focus. g0 represents acceleration of the oscillation device in the basic state and is set in advance. a and b represent coefficients.

The lens drive variable L1 is obtained using a formula indicated below.

L1=a·g1+b·t1

The acceleration of the image-capturing apparatus can be measured using the acceleration sensor 32, an IMU, and the microphone 37 that are included in the camera body 2.

When the lens drive variable L1 is smaller than the drive threshold L, as illustrated in (A) of FIG. 10, the acceleration g2 of the oscillation device 51 generating the oscillation indicating completion of being brought into focus is set to g0. Oscillation of the oscillation device 51 is generated after driving of a lens is finished. It is assumed that oscillation of the oscillation device 51 is controlled in the basic state, such that a camera operator perceives oscillation due to a lens being driven and the oscillation 61 indicating completion of being brought into focus in a state of distinguishing them.

When the lens drive variable L1 is larger than the drive threshold L, as illustrated in (B) of FIG. 10, the acceleration g2 of the oscillation device 51 generating the oscillation indicating completion of being brought into focus is set to be larger than g0. Alternatively, an interval of time t2 is provided. Alternatively, the acceleration g2 of the oscillation device 51 is set to be larger than g0, and the interval of time t2 is provided. This results in a camera operator easily perceiving oscillation generated due to a lens being driven and the oscillation 61 indicating completion of being brought into focus in a state of distinguishing them.

As described above, oscillation of the oscillation device 51 may be controlled taking into consideration oscillation during driving of a lens.

[Example of Control Performed Taking into Consideration Whether there is Need for Oscillation Feedback]

On the basis of, for example, image-capturing-environment information and image-capturing-setting information, the controller 4 may determine whether there is a need for oscillation feedback, and may dynamically perform on/off switching with respect to oscillation feedback (the oscillation mode).

It may be better if provision of oscillation feedback that is performed by the oscillation device is dynamically turned on and off according to a surrounding environment (an image-capturing environment) and settings.

It is assumed that, for example, the sound mode is on and a mechanical shutter mechanism is selected upon setting. When the controller 4 estimates that the image-capturing environment corresponds to a very quiet scene, using a result of sensing performed by the input-related device 3, the controller 4 automatically turns off the sound mode, changes the mechanical shutter mechanism to an electronic shutter mechanism, and performs switching to turn on the oscillation mode. Consequently, the image-capturing apparatus 1 does not produce any oscillation sound or sound due to a mechanical shutter, but the oscillation device provides oscillation. Accordingly, a camera operator understands an operation of the image-capturing apparatus 1.

What kind of scene the image-capturing environment corresponds to can be estimated by performing image recognition on a through-the-lens image (captured-image data) acquired by the imaging device 31, by performing sound recognition on data of sound collected by the microphone 37, and using position information regarding a position detected by a positioning section such as a global navigation satellite system (GNSS) signal receiver. The GNSS signal receiver may be included in, for example, the camera body 2.

Further, it is conceivable that eyelashes of a camera operator or a portion around eyes of the camera operator could be in contact with the image-capturing apparatus 1 while the camera operator is looking into the electronic viewfinder 22 of the image-capturing apparatus 1. This is another example.

When the controller 4 estimates, using a result of sensing performed by the input-related device 3, that the image-capturing environment corresponds to a scene in which eyes or glasses of a camera operator are situated near the image-capturing apparatus 1, the controller 4 performs control to make oscillation of the oscillation device 51 weaker, or performs control to turn off the oscillation mode. This makes it possible to, for example, prevent a camera operator from getting surprised by oscillation, prevent a camera operator from hurting his/her eye, or prevent glasses of a camera operator from being damaged. Whether eyes are situated close to the electronic viewfinder 22, that is, use information regarding use of the electronic viewfinder can be detected by the infrared sensor 36. In addition to the infrared sensor 36, a proximity sensor, a millimeter-wave sensor, a pressure sensor, or the like that can detect a distance or the area may be used. The use information regarding use of the electronic viewfinder corresponds to image-capturing-environment information.

As described above, oscillation of the oscillation device 51 may be dynamically controlled on the basis of image-capturing-environment information.

[Example of Performing Control According to Remaining Battery Life]

The controller 4 may control oscillation of the oscillation device 51 according to a result of monitoring, by the monitoring section 75, a remaining battery life and power consumption of the camera body. Information regarding the remaining battery life and the power consumption of the camera body is included in the state information regarding a state of the image-capturing apparatus.

(A) of FIG. 11 illustrates a relationship between a remaining battery life and acceptable power consumption. It is assumed that the acceptable power consumption is 1.0 when the remaining battery life is 100%, as illustrated in the figure.

For example, power consumption of the oscillation device 51 is about 1 W, which is relatively large. When the capacity of the battery 74 of the camera body 2 is reduced, the acceptable power consumption will also be reduced in proportion to the reduction in the capacity of the battery 74, as illustrated in (A) of FIG. 11. Thus, the power consumption of the camera body 2 may exceed its limit only at the moment when the oscillation device 51 oscillates, and this may result in the camera body 2 being shut down.

An uppermost diagram in (B) of FIG. 11 shows a waveform of oscillation of the oscillation device 51 when power consumption acceptable for the remaining battery life is greater than or equal to a sum of peak power consumption of the camera body and power consumption of the oscillation device. Two diagrams in a lower portion in (B) of FIG. 11 show waveforms of oscillation of the oscillation device 51 when the power consumption acceptable for the remaining battery life is less than the sum of the peak power consumption of the camera body and the power consumption of the oscillation device.

When the power consumption acceptable for the remaining battery life is less than the sum of the peak power consumption of the camera body and the power consumption of the oscillation device, as illustrated in the middle diagram of (B) of FIG. 11, a signal for the oscillation device is controlled such that oscillation is weaker, compared to when the power consumption acceptable for the remaining battery life is greater than or equal to the sum (refer to the uppermost diagram in (B) of FIG. 11). This makes it possible to reduce power consumption. This also prevents power consumption from exceeding acceptable power consumption just at the moment when oscillation is provided and to prevent the camera body 2 from being shut down.

Alternatively, control is performed to shift a timing of generating oscillation such that the oscillation device 51 oscillates after a peak of power consumption of the camera body 2, as illustrated in the lowermost diagram of (B) of FIG. 11. This prevents power consumption from exceeding acceptable power consumption just at the moment when oscillation is provided and to prevent the camera body 2 from being shut down.

As described above, oscillation of the oscillation device 51 may be controlled on the basis of information regarding a remaining battery life and power consumption of the camera body.

<Description of Other Operations of Image-Capturing Apparatus>

[Example of Providing Oscillation Indicating Reminder Information]

The example in which feedback on operation information regarding an operation of the image-capturing apparatus 1, such as completion of being brought into focus, start of exposure, and completion of exposure, is given to a camera operator in the form of an oscillation tactile sense provided by the oscillation device 51, has primarily been described in the embodiments above. However, the present technology is not limited thereto.

For example, in addition to providing operation information regarding an operation of the image-capturing apparatus 1 to a camera operator in the form of oscillation, oscillation 65 indicating reminder information may be provided by the oscillation device 51, as illustrated in FIG. 12. Further, reminders may be provided by sound in addition to providing the oscillation 65 indicating reminders.

Examples of the reminders include a notification that a remaining battery life is shortened, and a notification that there is danger in the surroundings such as approach of a dangerous object.

The notification that a remaining battery life is shortened is given when the remaining life of the battery 74 is shortened. Information indicating that a remaining battery life is shortened is information regarding a remaining life of the battery 74 serving as a drive power supply used to drive the image-capturing apparatus 1.

The fact that there is danger in the surroundings can be estimated using a result of sensing performed by the input-related device 3. More specifically, scenes such as a scene in which a vehicle is approaching a camera operator and a scene in which a camera operator is near cliffs are estimated, for example, by performing image recognition on a through-the-lens image (captured-image data) acquired by the imaging device 31, and using position information regarding a position detected by, for example, a GNSS signal receiver. Further, the scenes can be more accurately estimated taking into consideration sound information regarding sound such as environmental sound in the surroundings on which sensing is performed using a microphone.

A drive signal for oscillation indicating reminder information includes a signal that is not given out when the oscillation mode is off or a signal that is given out when the oscillation mode is off.

A drive signal for oscillation that indicates information indicating that a remaining battery life is shortened includes a signal that is not given out when the oscillation mode is off.

On the other hand, a drive signal for oscillation indicating that there is danger in the surroundings such as approach of a dangerous object includes a signal that is given out when the oscillation mode is off.

For example, when the oscillation mode has been set to on by a camera operator, the oscillation mode may be temporarily turned off in principle such that the oscillation device does not generate oscillation during exposure. This is described with reference to FIG. 13.

FIG. 13 is a processing flow used to describe control performed in principle during exposure with respect to the oscillation device in the image-capturing apparatus 1.

As illustrated in FIG. 13, when the controller 4 acquires information indicating that the shutter button 39 is in the full press state (ST1), the controller 4 controls the imaging device 31 such that image-capturing is started to be performed, and turns off oscillation of the oscillation device 51 (a state in which the oscillation mode is off) such that the oscillation device 51 is not driven during exposure (during performing image-capturing).

When the controller 4 acquires information indicating that exposure (ST2) performed on the imaging device 31 has been completed and captured-image data has been transmitted to a signal processor, the controller 4 cancels the state in which the oscillation mode is off (ST3).

This prevents a captured image from being blurred due to oscillation of the oscillation device during exposure.

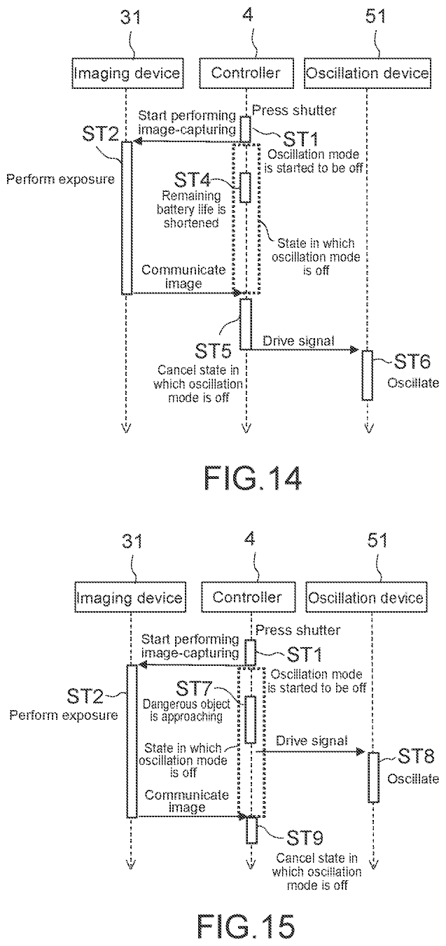

FIG. 14 is a processing flow used to describe control performed on the oscillation device when the controller 4 receives, during exposure, information indicating that a remaining battery life is shortened, the information corresponding to reminder information.

As illustrated in FIG. 14, when the controller 4 acquires information indicating that the shutter button 39 is in the full press state (ST1), the controller 4 controls the imaging device 31 such that image-capturing is started to be performed, and turns off the oscillation mode such that the oscillation device 51 is not driven during exposure (during performing image-capturing).

During exposure, the controller 4 receives the information indicating that a remaining battery life is shortened (ST4). A signal indicating that a remaining battery life is shortened includes a signal that is not given out when the oscillation mode is off. Thus, the controller 4 does not drive the oscillation device 51 in the state in which the oscillation mode is off during exposure.

When the controller 4 acquires information indicating that exposure (ST2) performed on the imaging device 31 has been completed and captured-image data has been transmitted to a signal processor, the controller 4 cancels the state in which the oscillation mode is off, and transmits a drive signal to the oscillation device 51 such that oscillation indicating that a remaining battery life is shortened is generated (ST5). The oscillation device 51 oscillates on the basis of the drive signal (ST6).

This prevents a captured image from being blurred due to oscillation provided during exposure, and makes it possible to promptly notify a camera operator that a remaining battery life is shortened.

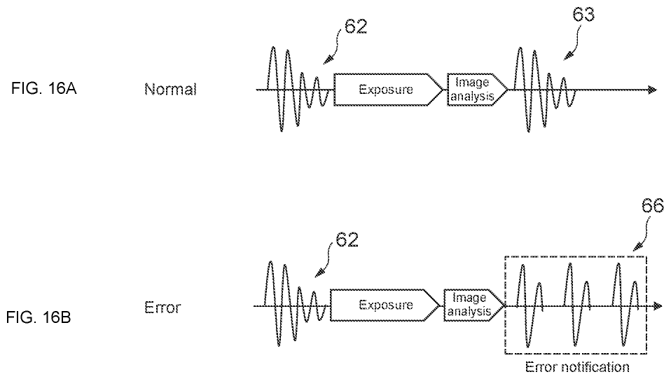

FIG. 15 is a processing flow used to describe control performed on the oscillation device when the controller 4 receives, during exposure, information indicating that there is danger in the surroundings.

As illustrated in FIG. 15, when the controller 4 acquires information indicating that the shutter button 39 is in the full press state (ST1), the controller 4 controls the imaging device 31 such that image-capturing is started to be performed, and turns off the oscillation mode such that the oscillation device 51 is not driven during exposure (during performing image-capturing).

During exposure, the controller 4 receives information indicating that there is danger in the surroundings. A signal indicating danger includes a signal that is not given out when the oscillation mode is off. Thus, the controller 4 transmits a drive signal to the oscillation device 51 such that oscillation indicating that there is danger in the surroundings is generated even when the oscillation mode is off (ST7). The oscillation device 51 oscillates on the basis of the drive signal (ST8). The oscillation enables a camera operator to recognize a dangerous state.

When the controller 4 acquires information indicating that exposure (ST2) performed on the imaging device 31 has been completed and captured-image data has been transmitted to a signal processor, the controller 4 cancels the state in which the oscillation mode is off (ST9).

This prevents serious damage such as accidents from being brought, and enables a camera operator to perform image-capturing in a safe environment.

[Example of Providing Oscillation Indicating Image-Capturing Information]

Here, provision of oscillation that is performed according to image-capturing information acquired by the imaging device 31, is described.

The image-capturing information includes information indicating whether a captured image acquired by the imaging device 31 is a normal image or an error image.

The controller 4 may control the oscillation device 51 such that oscillation indicating that an error image has been acquired is different from oscillation indicating that a normal image has been acquired.

There is a possibility that a preview screen will not be viewed just after image-capturing is performed using the image-capturing apparatus 1, which depends on the camera operator. Further, there is a possibility that an image projected onto a display will not be clearly visible to a camera operator due to aged eyes. In such a case, it is not easy to determine whether the captured image is an error image. The error image is, for example, an image in which a subject person is closing his/her eyes, or an image in which a subject is out of focus. Conversely, the normal image is an image in which a subject person is not closing his/her eyes and in which a subject is in focus.

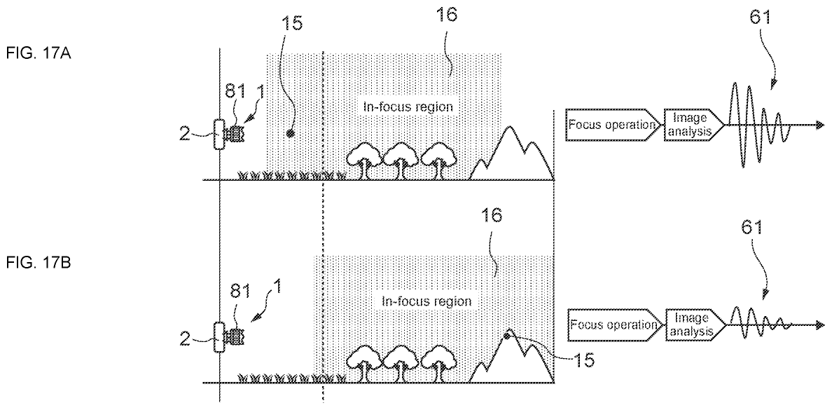

FIG. 16 illustrates, using diagrams, oscillation provided upon releasing a shutter after the shutter button is fully pressed.

(A) of FIG. 16 illustrates an example of an oscillation waveform when a captured image is a normal image.

(B) of FIG. 16 illustrates an example of an oscillation waveform when the captured image is an error image.

In the image-capturing apparatus 1, the oscillation 62 indicating start of exposure is generated, and then, exposure is performed to acquire captured-image data, as illustrated in FIG. 16 using the diagrams. The controller 4 performs image analysis on the captured-image data to determine whether the captured image is a normal image or an error image. For example, whether a blur has occurred in an image can be determined by detecting an edge in the image. When the subject is a person, whether the person is closing his/her eyes by performing facial image recognition.

When the capture image is a normal image, as illustrated in (A) of FIG. 16, the controller 4 indicates to a camera operator that exposure has been completed by the oscillation device 51 oscillating once.

When the capture image is an error image, as illustrated in (B) of FIG. 16, the controller 4 indicates to a camera operator that exposure has been completed by the oscillation device 51 oscillating multiple times such as three times and that the captured image is an error image.

As described above, oscillation of the oscillation device 51 may be controlled according to image-capturing information. Accordingly, a camera operator gets to know, by oscillation, that the captured image is an error image without viewing a preview screen.

[Other Examples of Providing Oscillation Indicating Operation Information Regarding Operation of Image-Capturing Apparatus]

A different kind of oscillation may be provided according to a focal length when the oscillation 61 indicating completion of being brought into focus is provided. Oscillation indicating a difference in the size of a focal length is oscillation indicating a state of being in focus.

This is described with reference to FIG. 17. FIG. 17 is a set of diagrams used to describe oscillation indicating completion of being brought into focus that is provided after the shutter button is half-pressed. Further, a circle denoted by reference numeral 15 in FIG. 17 indicates a point to be brought into focus.

(A) of FIG. 17 illustrates an example of an oscillation waveform when a point to be brought into focus is relatively nearby, that is, when the focal length is short.

(B) of FIG. 17 illustrates an example of an oscillation waveform when the point to be brought into focus is relatively distant, that is, when the focal length is long.

As illustrated in FIG. 17 using the diagrams, oscillation indicating completion of being brought into focus is generated when the shutter button is half-pressed to drive a lens (a focus operation), and the lens has been brought into focus. As illustrated in (A) and (B) of FIG. 17, the controller 4 may control oscillation of the oscillation device 51 such that oscillation is made stronger when the focal length is short and such that oscillation is made weaker when the focal length is long. This enables a camera operator to intuitively grasp the size of a focal length.

Note that, here, the oscillation indicating a difference in the size of a focal length has been described as an example of the oscillation 61 provided at the time of completion of being brought into focus. However, a different kind of oscillation may be provided according to a focal length when the oscillation 62 indicating start of exposure is provided.

Further, the controller 4 performs image analysis on captured-image data acquired after the focus operation, and when the controller 4 determines that the image is out of focus, the controller 4 may provide oscillation multiple times such as three times to notify a camera operator that the image is out of focus.

[Example of Providing Oscillation Indicating Operation Information Regarding Operation of Attachment Device]

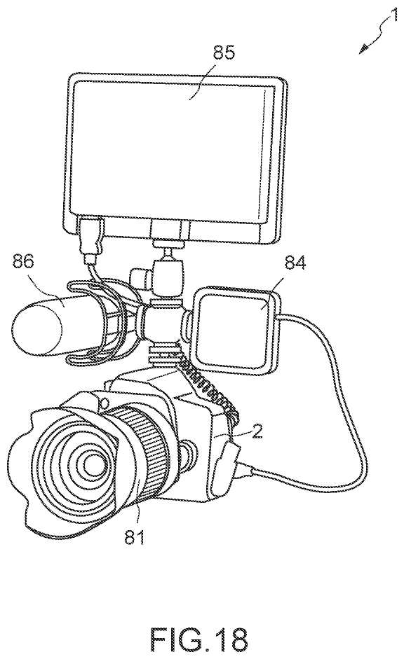

FIG. 18 is a perspective view of the image-capturing apparatus 1 to which a plurality of attachment devices is attached.

The image-capturing apparatus 1 illustrated in FIG. 18 includes the camera body 2, and includes the lens unit 81, the external flash 84, the monitor 85, and the high-sensitivity microphone 86 that are the attachment devices 8. Each attachment device 8 is attached to the camera body 2 directly or indirectly.

When a plurality of attachment devices is attached to the camera body 2, feedback on an operation performed by each attachment device may be given in the form of an oscillation tactile sense. In this case, different kinds of oscillation may be generated for respective attachment devices such that a camera operator can perceive which of the attachment devices performs the operation in a state of distinguishing them by oscillation.

For example, the monitor 85 may be configured such that a touch operation can be performed on the monitor 85, and oscillation that has a two-pulse oscillation waveform with a sine wave of 200 Hz and indicates that a touch operation has been performed, may be provided by the oscillation device 51. This oscillation waveform is a waveform that exhibits a feeling approximating a feeling experienced upon pressing a button.

Oscillation that has a ten-pulse oscillation waveform with a sine wave of 300 Hz and indicates that charging of the external flash 84 has been completed, may be provided by the oscillation device 51.

Oscillation that has a three-pulse oscillation waveform with a sine wave of 150 Hz and indicates that a level of the high-sensitivity microphone 86 exceeds a maximum level, may be provided by the oscillation device 51.

As described above, a change in oscillation waveform for each different attachment device enables a camera operator to intuitively grasp which attachment device has performed an operation indicated by oscillation.

<Other Specific Examples of Controlling Oscillation>

[Example of Controlling Oscillation According to Type of Attachment Device]

According to the type of attachment device attached to the camera body 2, the controller 4 may transform an oscillation waveform obtained when the oscillation mode is turned on/off or when the oscillation mode is on. Information regarding what kinds of attachment devices are attached to the camera body 2 is included in the state information regarding a state of the image-capturing apparatus.

The controller 4 can determine, from electrical-connection information, the type of an attachment device 8 when the attachment device 8 is attached to the camera body 2. Information regarding, for example, a weight of each attachment device 8 is information that is known in advance on the basis of the type of attachment device 8. For example, even in the case in which the oscillation waveform is the same, oscillation tends to be more difficult to be transmitted to a camera operator if the attachment device 8 weighs heavier. Thus, for example, the drive period of time of the oscillation device, the degree of strength of oscillation (amplitude), and the frequency are changed according to the weight of the attachment device, and this results in providing oscillation easily perceived by a camera operator.

Further, the controller 4 can acquire state information regarding a state of the image-capturing apparatus 1 from results of sensing performed by the acceleration sensor and the gyroscope when the attachment device 8 is attached.

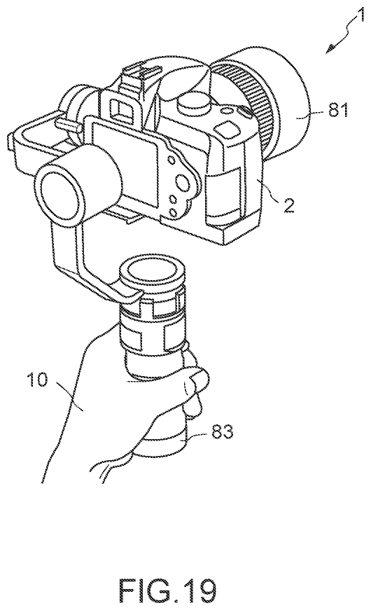

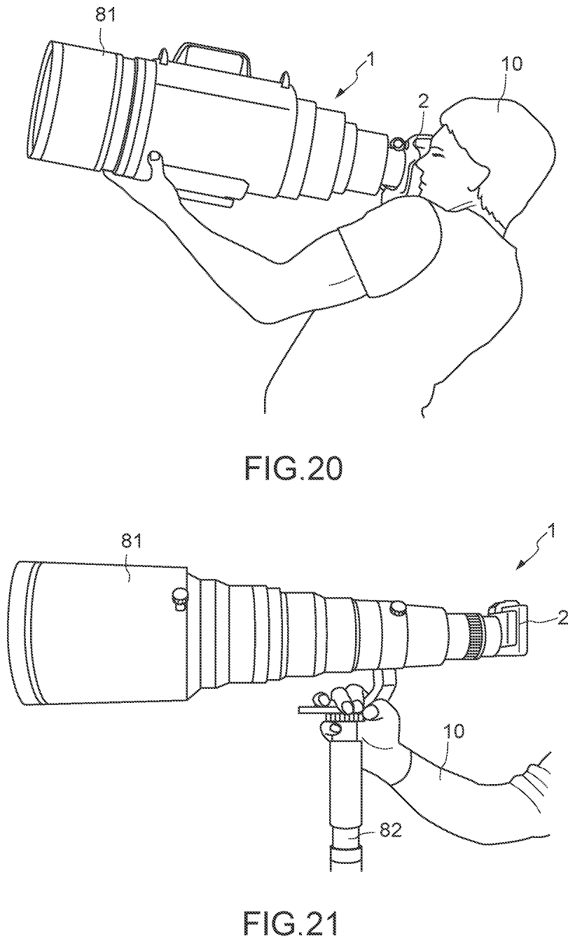

FIG. 19 is a perspective view of the image-capturing apparatus 1 to which the gimbal 83 is attached as the attachment device 8 in addition to the lens unit 81.

FIG. 21 is a perspective view of the image-capturing apparatus 1 to which the leg 82 such as a tripod is attached as the attachment device 8 in addition to the lens unit 81 including a huge lens.

When the controller 4 determines, on the basis of electrical-connection information and results of sensing performed by the acceleration sensor and the gyroscope, that the gimbal 83 or the leg 82 is attached, the controller 4 sets the oscillation mode to be off. It is often the case that a camera operator does not hold the camera body 2 in a usage configuration in which the gimbal 83 or the leg 82 is used. Thus, the oscillation mode is turned off.

Further, when the controller 4 determines that, for example, an external shutter is attached as the attachment device 8, the controller 4 may turn off the oscillation mode to switch to control performed by giving feedback using sound. In other words, the controller 4 may turn on the sound mode. It is often the case that a camera operator does not hold the camera body 2 in a usage configuration in which an external shutter is attached. Thus, the oscillation mode is turned off. The external shutter is, for example, a wired or wireless shutter remote controller.

Here, in some cases, the camera body 2 is supported, using the leg 82, in a location such as a rocky tract in which the footing is bad. The controller 4 determines that the leg 82 is attached as the attachment device 8 and then determines that the leg 82 is arranged at an unstable place, the controller 4 may control the oscillation device such that the oscillation device generates oscillation indicating reminders to urge a camera operator to reconsider a place at which the leg 82 is arranged.

The determination that the leg 82 is arranged at an unstable place can be performed by, for example, estimating, from results of sensing performed by the acceleration sensor and the gyroscope, that the camera body 2 is not placed at a fixed position.

[Example of Controlling Oscillation According to Type of Lens Unit]

The controller 4 may control oscillation of the oscillation device 51 according to the type of lens unit 81. As described above, a typical way in which the image-capturing apparatus is held differs depending on the type of lens unit 81.

For example, it is often the case that, when the lens unit includes a monofocal lens, a camera operator does not hold a lens but holds the camera body 2 with his/her two hands.

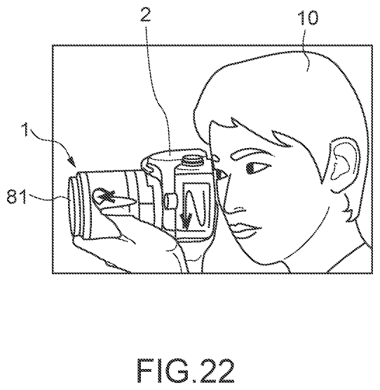

It is often the case that, when the lens unit includes a zoom lens of a typical size, a camera operator 10 puts his/her left hand under the lens and holds the camera body 2 with his/her right hand, as illustrated in FIG. 22.

When the lens unit 81 includes a huge lens, as illustrated in FIGS. 20 and 21, the camera operator 10 supports the lens with his/her left hand and holds the camera body 2 with his/her right hand, as illustrated in FIG. 20, or uses the leg 82, as illustrated in FIG. 21. In general, the leg 82 is used when a huge lens is used.

The controller 4 can determine the type of a lens unit 81 when the lens unit 81 is attached to the camera body 2.

When the controller 4 determines that a huge lens that easily causes a hand-induced shake is attached, the controller 4 automatically sets the oscillation mode to be off. This makes it possible to prevent a hand-induced shake caused by a huge lens from being encouraged due to oscillation of the oscillation device.

When the controller 4 determines that the lens unit 81 including a monofocal lens is attached and further determines that a distribution of acceleration that occurs in the camera body 2 is uneven, the controller 4 may control a drive signal such that a waveform of oscillation of the oscillation device 51 is different from the oscillation waveform obtained when the distribution of acceleration is even.

The distribution of acceleration that occurs in the camera body 2 can be calculated using a result of sensing performed by the acceleration sensor.

For example, on the basis of a result of the distribution of acceleration, the controller 4 may set, to be a reference, one of two hands with which the image-capturing apparatus 1 is held, the one of the two hands being a hand with which oscillation is felt weakly. Then, the controller 4 may control a drive signal such that acceleration obtained due to the oscillation device is increased relative to a threshold for the reference sensitivity. Further, on the basis of the result of the distribution of acceleration, the controller 4 may calculate a difference in sensitivity between the two hands with which the image-capturing apparatus 1 is held, and, when the difference in sensitivity exhibits a value that is greater than or equal to a certain threshold, the controller 4 may control a drive signal for the oscillation device 51 such that the oscillation mode is turned off or the obtained acceleration is decreased.

When the controller 4 determines that the lens unit 81 including a zoom lens of a typical size and further determines that a distribution of acceleration that occurs in the camera body 2 is uneven, the controller 4 may control a drive signal such that a waveform of oscillation of the oscillation device 51 is different from the oscillation waveform obtained when the distribution of acceleration is even.

It is often the case that, when the lens unit includes a zoom lens of a typical size, a camera operator puts his/her left hand under the lens and holds the camera body 2 with his/her right hand, as illustrated in FIG. 22. On the basis of a result of the distribution of acceleration, the controller 4 may control a drive signal for the oscillation device 51, where sensitivity of the left hand is used as a reference for lens-operation-related oscillation such as the oscillation 61 indicating completion of being brought into focus, and sensitivity of the right hand is used as a reference for shutter-related oscillation such as the oscillation 62 indicating start of exposure and the oscillation 63 indicating completion of exposure.

When the controller 4 determines that the lens unit 81 including a huge lens is attached and further determines that the leg 82 is not attached, the controller 4 may determine that the huge lens easily causes a hand-induced shake and may turn off the oscillation mode.

When the controller 4 determines that the lens unit 81 including a huge lens is attached and further determines that the leg 82 is attached, the controller 4 may turn off the oscillation mode or may control the oscillation device 51 such that oscillation is made weaker.

As described above, oscillation of the oscillation device 51 may be controlled taking into consideration the type of lens unit and further taking into consideration a state in which the lens unit is held by a camera operator.

[Example of Controlling Oscillation According to Zooming State of Lens Unit]

When the lens unit includes a zoom lens, the controller 4 may control a drive signal for the oscillation device 51, according to a zoom state of the lens unit 81.

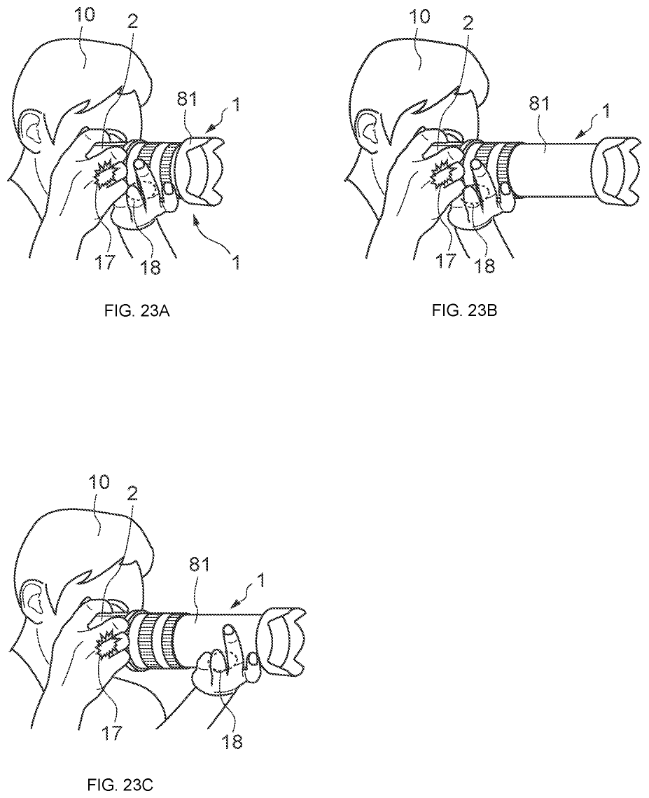

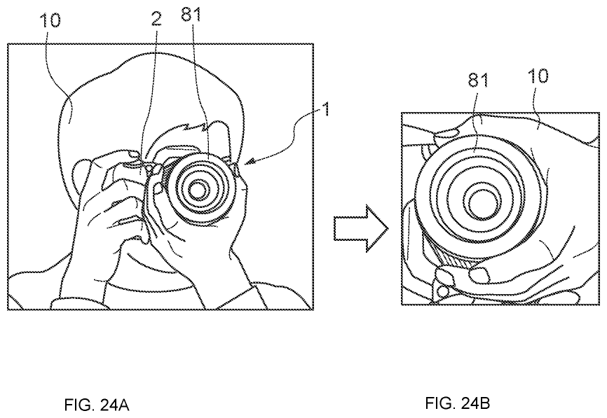

(A) to (C) of FIG. 23 illustrate different zoom states. In (A) to (C) of FIG. 23, the camera operator 10 holds the camera body 2 with his/her right hand and puts his/her left hand under the lens unit 81. In the figure, reference numeral 17 indicates a position at which oscillation is generated by the oscillation device 51, and reference numeral 18 indicates a point of contact of the lens unit 81 with the hand of the camera operator 10.

(A) of FIG. 23 illustrates a state in which lens zooming is not performed, and a point 17 of contact of the lens unit 81 with the hand of the camera operator 10 is situated near a point 18 of generation of oscillation.

(B) and (C) of FIG. 23 each illustrate a state in which lens zooming is performed, and it is assumed that the zoom rate in (C) is higher than that in (B). The hand in (B) of FIG. 23 is situated at the same position as the hand in (A) of FIG. 23, and the point 17 of contact of the lens unit 81 with the hand of the camera operator 10 is situated near the point 18 of generation of oscillation. The hand in (C) of FIG. 23 is situated at a position different from that of the hand in (A) of FIG. 23, and the hand is situated away from the camera body 2. In (C) of FIG. 23, the point 17 of contact of the lens unit 81 with the hand of the camera operator 10 is situated away from the point 18 of generation of oscillation.

Here, when a barrel of a lens unit including a zoom lens is elongated in the optical-axis direction by zooming being performed, a hand-induced shake easily occurs.

When a zoom rate z1 of the lens unit 81 is less than or equal to a first threshold Zh1, the controller 4 turns on the oscillation mode, as illustrated in (A) of FIG. 23. In this case, control may be performed according to the zoom rate such that acceleration of oscillation provided when oscillation feedback is given is decreased. This makes it possible to reduce a hand-induced shake.

When the zoom rate z1 of the lens unit 81 is greater than the first threshold Zh1, the controller 4 turns off the oscillation mode, as illustrated in (B) of FIG. 23. This makes it possible to reduce a hand-induced shake.

When the zoom rate z1 of the lens unit 81 is greater than a second threshold Zh2 (Zh2>Zh1), the controller 4 estimates that the camera operator 10 is holding a lens with his/her left hand and thus the point 17 of contact is situated away from the point 18 of generation of oscillation, as illustrated in (C) of FIG. 23. The controller 4 controls a drive signal such that oscillation of the oscillation device 51 is made stronger, in order to definitely give oscillation feedback to the left hand with which a lens is being held.

[Example of Controlling Oscillation According to Dynamically Changed State of Holding Performed by Camera Operator]

The controller 4 may control oscillation of the oscillation device 51 according to a dynamically changed state in which the camera operator 10 holds the image-capturing apparatus 1.

When the camera operator 10 changes a zoom rate or a stop, the camera operator 10 may change a holding state, such as holding the lens unit 81 from the bottom of the lens unit 81, as illustrated in (A) of FIG. 24, and holding the lens unit 81 from the side of the lens unit 81, as illustrated in (B) of FIG. 24.

When there is a change in holding state from (A) to (B) of FIG. 24, a degree of strength of a force with which the lens unit 81 is held is reduced due to human engineering characteristics. This results in easily creating a space between the lens unit 81 the palm of a hand. Further, not the entirety of the palm of a hand but a finger is often brought into contact with the lens unit 81. Consequently, the area of contact tends to be made smaller.

The controller 4 may change a degree of strength of oscillation of the oscillation device, the frequency of the oscillation, and an oscillation pattern according to the holding state.

Specifically, the controller 4 determines whether the camera operator 10 is holding the lens unit 81 from the bottom of the lens unit 81, as illustrated in (A) of FIG. 24 or from the side of the lens unit 81, as illustrated in (B) of FIG. 24. For example, when the controller 4 determines that the lens unit 81 is held from the side of the lens unit 81, the controller 4 controls a drive signal for the oscillation device such that acceleration is increased and an oscillation-provision period of time (a drive period of time) is made relatively longer to obtain a higher-sensitivity range of frequencies, compared to when the lens unit 81 is held from the bottom of the lens unit 81. This results in there being only a small change in, for example, a degree of strength of oscillation perceived by a camera operator regardless of a change in holding state. This makes it possible to provide oscillation stably.

For example, a contact sensor may be included in the lens unit and a holding state in which a camera operator holds the lens unit with hands may be detected. Alternatively, an initial value of position information regarding a position of a hand may be acquired, and a holding state in which the lens unit is held with hands of a camera operator may be estimated using a zoom rate.

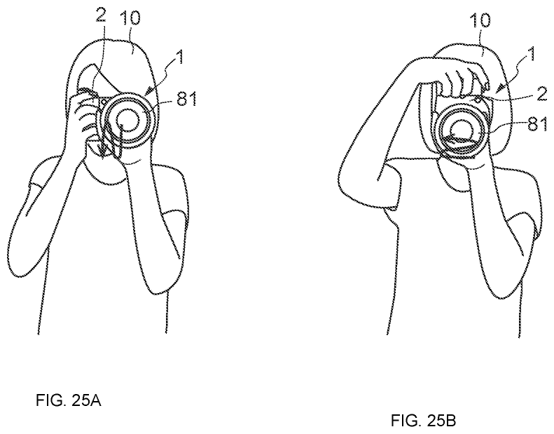

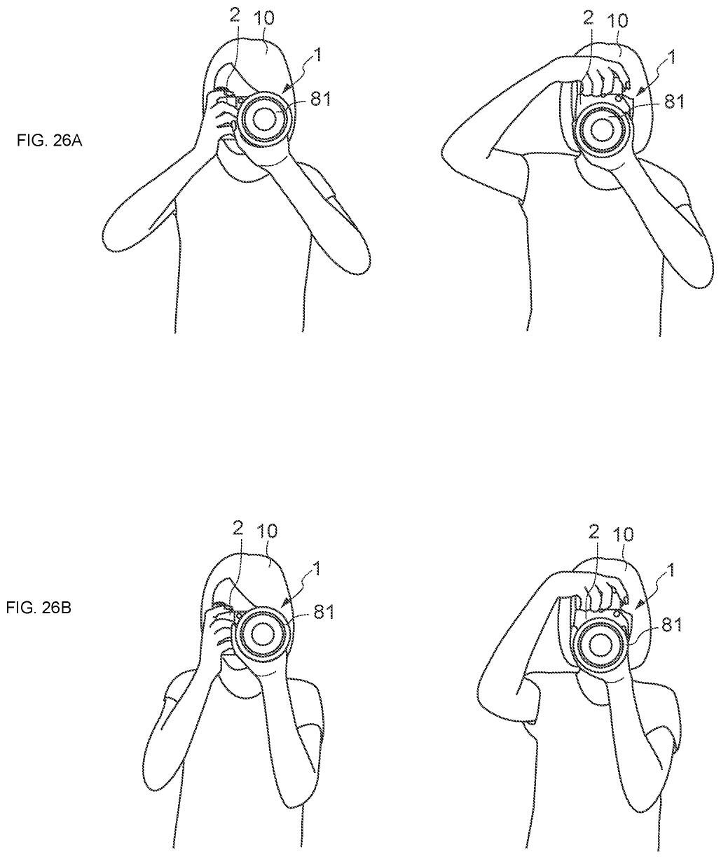

Further, the camera operator 10 may change the holding state, such as holding the camera body 2 in a laterally long state, as illustrated in (A) of FIG. 25, and holding the camera body 2 in a longitudinally long state, as illustrated in (B) of FIG. 24.

For example, the oscillation device 51 is included in the camera body 2 such that the oscillation direction of the oscillation device 51 is a height direction of the camera body 2 (a Z-axis direction in FIG. 1). A direction in which oscillation is provided to a camera operator by the oscillation device 51 when the image-capturing apparatus 1 is held in a laterally long state is different from a direction in which oscillation is provided to the camera operator by the oscillation device 51 when the image-capturing apparatus 1 is held in a longitudinally long state. Further, the sensitivity of a human hand also differs depending on the oscillation direction.

The controller 4 may change a drive signal for the oscillation device 51 according to the orientation of the camera body 2. For example, oscillation of the oscillation device may be made stronger when the camera body 2 is held in a longitudinally long state than when the camera body 2 is held in a laterally long state. Note that the example in which there are two orientations of the camera body 2 that correspond to the laterally long state and the longitudinally long state, has been described. However, the camera body 2 is used by being held obliquely. The “orientation of the camera body” includes an oblique state in addition to the longitudinally long state and the laterally long state.

The orientation of the camera body 2 can be estimated from, for example, pose information regarding a pose of the camera body 2 that is estimated using a through-the-lens image acquired by the imaging device 31 and results of sensing performed by, for example, the acceleration sensor 32 and the gyroscope 33.

Here, the example in which the oscillation device 51 is included in the camera body 2 such that the oscillation direction of the oscillation device 51 is the height direction of the camera body 2, has been described. However, the present technology is not limited thereto. The oscillation device 51 may be included in the camera body such that the oscillation direction of the oscillation device 51 is an X-axis direction or a Y-axis direction in FIG. 1.

[Example of Controlling Oscillation According to Dynamic Shake Induced by Camera Operator]

The controller 4 may control a drive signal for the oscillation device 51 according to a dynamic shake induced due to a pose of the camera operator 10 who is holding the image-capturing apparatus 1.

(A) of FIG. 26 illustrates the camera operator 10 who is not pressing his/her arms tightly to his/her sides and thus not successful in holding the image-capturing apparatus 1 in a fixed manner. On the other hand, (B) of FIG. 26 illustrates the camera operator 10 who is pressing his/her arms tightly to his/her sides and thus successful in holding the image-capturing apparatus 1 in a fixed manner.

The state in which the image-capturing apparatus 1 is not held in a fixed manner and a dynamic shake induced by the camera operator 10 is given to the image-capturing apparatus 1 can be estimated using a through-the-lens image acquired by the imaging device 31 and results of sensing performed by, for example, the acceleration sensor 32 and the gyroscope 33. The dynamic shake induced by the camera operator 10 can be a hand-induced shake.

When a sum of an amount of a shake induced by the hand of the camera operator 10 and an amount of oscillation of the oscillation device is smaller than an oscillation amount that accepts hand-induced-shake correction, the controller 4 turns on the oscillation mode, and controls the oscillation 62 and oscillation 63 provided upon releasing a shutter, such that oscillation of the oscillation device 51 is oscillation with a basic oscillation waveform.

When the sum of the amount of a shake induced by the hand of the camera operator and the amount of oscillation of the oscillation device is larger than or equal to the oscillation amount accepting the hand-induced-shake correction, the controller 4 turns off the oscillation mode, or controls the oscillation 62 and oscillation 63 provided upon releasing a shutter, such that the oscillation is weaker than the oscillation with the basic oscillation waveform.

As described above, in the camera body 2 serving as an information processing apparatus that includes the controller 4 of the present embodiment, oscillation of the oscillation device 51 included in the camera body 2 is controlled on the basis of at least one of image-capturing-environment information regarding an image-capturing environment of the image-capturing apparatus 1, image-capturing-setting information set by a camera operator, or state information regarding a state of the image-capturing apparatus 1. This results in properly providing information related to the image-capturing apparatus 1 to a camera operator in the form of an oscillation tactile sense.

<Information Processing Method Related to Control Performed on Oscillation Device>

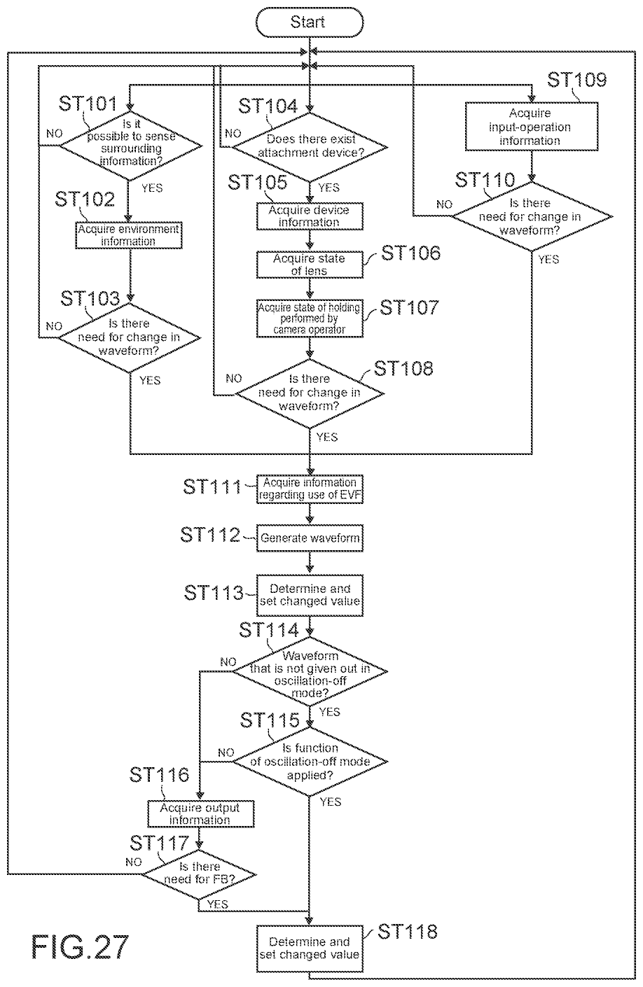

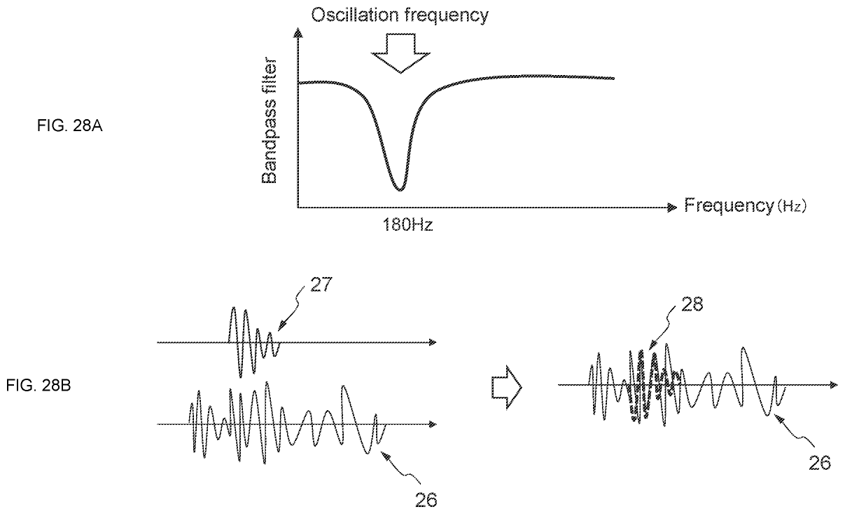

A flow of an information processing method related to control performed by the controller 4 on an oscillation device is described with reference to FIG. 27. A “change in a waveform of oscillation of an oscillation device” includes not only a change in oscillation waveform, but also the case in which an oscillation device does not oscillate.

As illustrated in FIG. 27, when control on an oscillation device is started to be performed, the controller 4 determines whether a sensing result that corresponds to image-capturing-environment information regarding an image-capturing environment in the surroundings can be acquired from the input-related device 3 (ST101). Examples of the sensing result include image data acquired by the imaging device 31 and data of sound detected by a microphone. The controller 4 determines that the sensing result is not allowed to be acquired (NO), the process returns to “Start” to be repeated.

When the controller 4 determines that the sensing result can be acquired (YES), the process moves on to ST102. In ST102, the controller 4 acquires the image-capturing-environment information regarding an image-capturing environment in the surroundings on the basis of the sensing result.

Next, using the environment-information DB 72, the controller 4 determines whether to change a waveform of oscillation of an oscillation device, according to the image-capturing-environment information (ST103).

When the controller 4 determines that the oscillation waveform is to be changed (YES), the process moves on to ST111. When the controller 4 determines that the oscillation waveform is not to be changed (NO), the process returns to “Start” to be repeated.

The controller 4 determines whether there is the attachment device 8 attached to the camera body 2 (ST104).

When the controller 4 determines that there is no attachment device 8 (NO), the process returns to “Start” to be repeated.

When the controller 4 determines that there is the attachment device 8 (YES), the process moves on to ST105. The controller 4 acquires type information regarding the type of the attachment device 8 from electrical-connection information regarding electrical connection established between the camera body 2 and the attachment device 8.

In ST105, the controller 4 acquires information regarding the attached attachment device using the attachment-device DB 71.

Next, the controller 4 acquires information regarding a lens state such as a zoom state of a zoom lens of the lens unit 81 (ST106).

Next, the controller 4 acquires a holding state of holding performed by a camera operator on the basis of the result of sensing performed by the input-related device 3 (ST107).

Next, the controller 4 determines whether to change the oscillation waveform on the basis of the attachment-device information, the lens-state information, and holding-state information (ST108).

When the controller 4 determines that the oscillation waveform is to be changed (YES), the process moves on to ST111.

When the controller 4 determines that the oscillation waveform is not to be changed (NO), the process returns to “Start” to be repeated.

The attachment-device information, the lens-state information, and the holding-state information correspond to state information regarding a state of an image-capturing apparatus.

The controller 4 acquires input-operation information regarding an input operation performed by the camera operator (ST109). The input-operation information is image-capturing-setting information set by the camera operator performing an input operation.

Next, the controller 4 determines whether to change the oscillation waveform, on the basis of the acquired input-operation information (ST110).

When the controller 4 determines that the oscillation waveform is to be changed (YES), the process moves on to ST111.

When the controller 4 determines that the oscillation waveform is not to be changed (NO), the process returns to “Start” to be repeated.

In ST111, the controller 4 acquires use information regarding use of the electronic viewfinder (EVF) 22 on the basis of the result of sensing performed by the input-related device 3.

Next, the controller 4 generates a waveform of oscillation of the oscillation device 51 (a drive signal), using the image-capturing-environment information, the state information regarding a state of the image-capturing apparatus 1, the image-capturing-setting information regarding image-capturing setting performed by a camera operator, the use information regarding use of the electronic viewfinder 22, and information stored in the section 73 for information regarding a user attribute and camera specifications (ST112), and changes a set value for the oscillation waveform in the current setting to set the changed set value (ST113).

Next, the controller 4 determines whether the drive signal includes a signal that is not given out when the oscillation mode is off (ST114).

When the controller 4 determines that the drive signal does not include the signal that is not given out when the oscillation mode is off (NO), the process moves on to ST116.

When the controller 4 determines that the drive signal includes the signal that is not given out when the oscillation mode is off (YES), the controller 4 determines whether the oscillation mode has been set to off (ST115).

When the controller 4 determines that the oscillation mode has been set to off (YES), the process moves on to ST118.

When the controller 4 determines that the oscillation mode has not been set to off (NO), the process moves on to ST116.

In ST116, the controller 4 acquires a result of sensing performed by the input-related device 3 (output information), such as acceleration and sound pressure that are detected in the image-capturing apparatus 1.

Next, on the basis of the acquired output information, the controller 4 determines whether to include feedback on the acquired output information in next oscillation of the oscillation device 51 (ST117).

When the controller 4 determines that the feedback is to be included (YES), the process moves on to ST118.

When the controller 4 determines that the feedback is not to be included (NO), the process returns to “Start” to be repeated.

In ST118, the controller 4 changes a set value for the oscillation waveform (the drive signal) in the current setting to set the changed set value. Thereafter, the process returns to “Start” to be repeated.

As described above, in the information processing method of the present embodiment, oscillation of an oscillation device included in a camera body is controlled on the basis of at least one of image-capturing-environment information regarding an environment for image-capturing performed by the image-capturing apparatus 1, image-capturing-setting information set by a camera operator, or state information regarding a state of the image-capturing apparatus 1. This makes it possible to properly provide information related to the image-capturing apparatus to a camera operator in the form of an oscillation tactile sense.

### Other Embodiments

The embodiments of the present technology have been described above. The present technology is not limited to the embodiments described above, and of course various modifications may be made thereto without departing from the scope of the present technology.

Other embodiments are described below.

The example in which the camera body includes the oscillation device has been described in the embodiments above. However, the oscillation device may be provided to each of the camera body and the lens unit. Further, it is sufficient if at least one oscillation device is provided, and, for example, a plurality of oscillation device may be included in the camera body.

When, as described above, a plurality of oscillation devices is provided to the entirety of the image-capturing apparatus, which oscillation device is caused to oscillate and how to oscillate the oscillation device are selectively determined as appropriate taking into consideration characteristics of an oscillation device, such as a difference in holding state between the types of lens units, a timing of generating oscillation, acceleration, a range of frequencies, and an oscillation direction.

Further, the example in which the controller 4 controlling oscillation of the oscillation device 51 is provided to the camera body 2, and the camera body 2 serves as an information processing apparatus, has been described in the embodiments above. However, the controller 4 may be provided to an information processing apparatus that is different from the camera body 2.

Furthermore, the example of capturing a still image has been described in the embodiments above. However, oscillation feedback may be given while a moving image is being captured. In this case, sound of oscillation of an oscillation device may be recorded in the captured moving image.

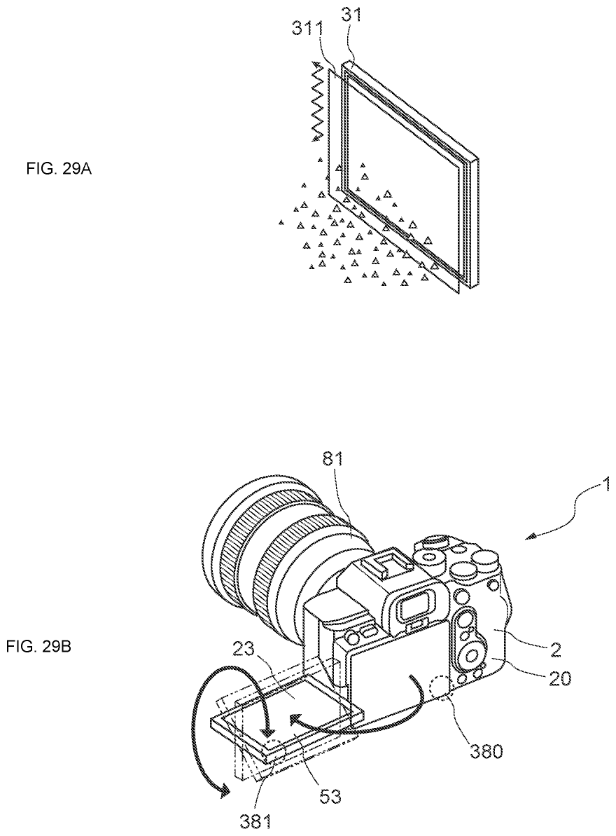

For this reason, the moving image can be filtered to cut a range of frequencies of oscillation sound (the oscillation frequency in the figure), as illustrated in (A) of FIG. 28. Alternatively, an opposite phase 28 of a frequency 27 of oscillation sound may be added to recording data 26, as illustrated in (B) of FIG. 28. This makes it possible to obtain a moving image including sound from which oscillation sound has been removed.

(A) of FIG. 29 is a diagram used to describe an anti-dusting system.

Using a piezoelectric element, the anti-dusting system causes a filter 311 provided on an entire surface of the imaging device 31 to oscillate with ultrasound of 70,000 times or more per second, and changes a method for swinging the filter 311 to remove attached dust and dirt.

The above-described function of an oscillation device may be implemented by a piezoelectric element used in an anti-dusting system. In this case, it is favorable that a piezoelectric element with a low frequency be used.

As described above, a piezoelectric element (an oscillation device) includes both a function of oscillation feedback and a function of an anti-dusting system.

(B) of FIG. 29 is a perspective view of the image-capturing apparatus 1. This image-capturing apparatus 1 includes the camera body 2 and the lens unit 81. The camera body 2 includes an open-and-close section 23 that is coupled to the housing 20 through a coupling portion (not illustrated).

The open-and-close section 23 is coupled to the camera body 2 through the coupling portion to be capable of being opened and closed by being rotated about an open-and-close axis that extends in parallel with a height direction of the camera body 2 and to be capable of being rotated about a rotational axis that is orthogonal to the open-and-close axis. The open-and-close section 23 includes the display 53. (B) of FIG. 29 illustrates an example of a state in which the open-and-close section 23 is opened. The open-and-close section 23 can be closed in a state of overlapping the housing 20.

In the example illustrated in (B) of FIG. 29, a magnet 381 is provided to the open-and-close section 23, and a magnetic sensor 380 is provided to the magnet 381. Note that the magnetic sensor 380 may be provided to the open-and-close section 23, and the magnet 381 may be provided to the housing 20. The magnetic sensor 380 detects a degree of strength of a magnetic field. The magnetic sensor 380 and the magnet 381 are situated close to each other when the open-and-close section 23 is closed. Thus, the magnetic sensor 380 can detect the magnet 381. As described above, the magnet 381 and the magnetic sensor 380 can be used as an open-and-close detector that detects a state in which the open-and-close section 23 is open or closed. Further, a magnet of the oscillation device (VCM) described above may be used as the magnet 381 used as the open-and-close detector.

As described above, the oscillation device may include both a function of oscillation feedback and an open-and-close detector of the open-and-close section.

Note that the present technology may also take the following configurations.

(1) An information processing apparatus, including
a controller that controls oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.

(2) The information processing apparatus according to (1), in which
the oscillation indicates information related to the image-capturing apparatus.

(3) The information processing apparatus according to (2), in which
the information related to the image-capturing apparatus includes at least one of operation information regarding an operation of the image-capturing apparatus, reminder information, operation information regarding an operation of an attachment device that is attached to the camera body, or image-capturing information that is acquired by the imaging device.

(4) The information processing apparatus according to (3), in which
the operation information regarding an operation of the image-capturing apparatus includes information regarding a state in which the subject is in focus, information regarding start of exposure performed on the imaging device, and information regarding completion of the exposure.

(5) The information processing apparatus according to (4), in which
the image-capturing apparatus includes a shutter button that is operated to be half-pressed and fully pressed,
the controller controls the oscillation of the oscillation device, which indicates the state in which the subject is in focus and is provided in response to the shutter button being half-pressed, and
the controller controls the oscillation of the oscillation device, which indicates the start of the exposure and is provided in response to the shutter button being fully pressed, and the oscillation of the oscillation device, which indicates the completion of the exposure and is provided in response to the shutter button being fully pressed.

(6) The information processing apparatus according to (4), in which
the controller performs control such that the oscillation being provided by the oscillation device and indicating the state in which the subject is in focus differs depending on a focal length.

(7) The information processing apparatus according to any one of (3) to (6), in which
the image-capturing information includes information regarding whether a captured image that is acquired by the imaging device is a normal image or an error image, and
the controller controls the oscillation of the oscillation device such that oscillation indicating that the error image has been acquired is different from oscillation indicating that the normal image has been acquired.

(8) The information processing apparatus according to any one of (3) to (7), in which
during exposure performed on the imaging device, the controller performs control such that the oscillation of the oscillation device is set to off.

(9) The information processing apparatus according to any one of (3) to (8), in which
a drive signal of oscillation indicating the reminder information includes a signal that is not given out when an oscillation mode for the oscillation device is off or a signal that is given out when the oscillation mode is off,
when the controller receives, during exposure performed on the imaging device, the reminder information including the signal not being given out when the oscillation mode is off, the controller controls the oscillation device such that the oscillation indicating the reminder information is generated after the exposure performed on the imaging device is completed, and
when the controller receives, during exposure performed on the imaging device, the reminder information including the signal being given out when the oscillation mode is off, the controller controls the oscillation device such that the oscillation indicating the reminder information is generated during the exposure performed on the imaging device.

(10) The information processing apparatus according to any one of (3) to (9), in which
the reminder information includes at least one of information regarding a remaining life of a battery that serves as a drive power supply used to drive the image-capturing apparatus, or information regarding the image-capturing-environment information.

(11) The information processing apparatus according to any one of (3) to (10), in which
a plurality of the attachment devices different from each other is attached to the image-capturing apparatus, and
the controller controls the oscillation of the oscillation device such that oscillation indicating the operation information regarding an operation of the attachment device differs depending on the attachment device of the plurality of the attachment devices.

(12) The information processing apparatus according to any one of (2) to (11), in which
the controller performs control such that first oscillation and second oscillation that respectively indicate the different pieces of information related to the image-capturing apparatus are distinguishable by the camera operator.

(13) The information processing apparatus according to any one of (1) to (12), in which
the image-capturing-setting information includes at least one of a setting of a shutter speed, a setting of a frame rate, a setting of a single-shooting mode or a consecutive-shooting mode, or a setting of the image-capturing environment.

(14) The information processing apparatus according to any one of (1) to (13), in which
the state information regarding a state of the image-capturing apparatus includes at least one of type information regarding the type of the attachment device attached to the camera body, form information regarding the form of the attachment device, holding-state information regarding a state in which the camera operator holds the image-capturing apparatus, or information regarding a remaining life of a drive power supply used to drive the image-capturing apparatus and power consumption of the camera body.

(15) The information processing apparatus according to any one of (1) to (14), in which
the image-capturing apparatus includes a zoom lens, and
the controller controls the oscillation of the oscillation device taking into consideration oscillation provided during driving of the zoom lens.

(16) The information processing apparatus according to any one of (1) to (15), in which
the controller controls the oscillation of the oscillation device taking into consideration oscillation sound produced due to the oscillation device.

(17) The information processing apparatus according to any one of (1) to (16), in which
the image-capturing apparatus includes a mechanical shutter, and
the controller controls the oscillation of the oscillation device taking into consideration oscillation provided when the mechanical shutter is operated.

(18) The information processing apparatus according to any one of (1) to (17), in which
the controller controls next oscillation of the oscillation device using oscillation information regarding oscillation of the image-capturing apparatus.

(19) An information processing method, including
controlling oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.

(20) A program that causes an information processing apparatus to perform a process including
controlling oscillation of an oscillation device that provides oscillation to a camera operator, on the basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.

### REFERENCE SIGNS LIST

1 image-capturing apparatus
2 camera body
3 input-related device
4 controller
8 attachment device
10 camera operator
11 mechanical shutter
31 imaging device
39 shutter button
51 oscillation device
61 oscillation indicating state of being in focus
62 oscillation indicating information regarding start of exposure
63 oscillation indicating information regarding completion of exposure
74 battery (drive power supply)
81 lens unit (attachment device)
82 leg (attachment device)
83 gimbal (attachment device)
84 external flash (attachment device)
85 monitor (attachment device)
86 high-sensitivity microphone (attachment device)

1. An information processing apparatus, comprising
a controller that controls oscillation of an oscillation device that provides oscillation to a camera operator, on a basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including a camera body that includes the oscillation device and an imaging device that captures an image of a subject.

2. The information processing apparatus according to claim 1, wherein
the oscillation indicates information related to the image-capturing apparatus.

3. The information processing apparatus according to claim 2, wherein
the information related to the image-capturing apparatus includes at least one of operation information regarding an operation of the image-capturing apparatus, reminder information, operation information regarding an operation of an attachment device that is attached to the camera body, or image-capturing information that is acquired by the imaging device.

4. The information processing apparatus according to claim 3, wherein
the operation information regarding an operation of the image-capturing apparatus includes information regarding a state in which the subject is in focus, information regarding start of exposure performed on the imaging device, and information regarding completion of the exposure.

5. The information processing apparatus according to claim 4, wherein
the image-capturing apparatus includes a shutter button that is operated to be half-pressed and fully pressed,
the controller controls the oscillation of the oscillation device, which indicates the state in which the subject is in focus and is provided in response to the shutter button being half-pressed, and
the controller controls the oscillation of the oscillation device, which indicates the start of the exposure and is provided in response to the shutter button being fully pressed, and the oscillation of the oscillation device, which indicates the completion of the exposure and is provided in response to the shutter button being fully pressed.

6. The information processing apparatus according to claim 4, wherein
the controller performs control such that the oscillation being provided by the oscillation device and indicating the state in which the subject is in focus differs depending on a focal length.

7. The information processing apparatus according to claim 3, wherein
the image-capturing information includes information regarding whether a captured image that is acquired by the imaging device is a normal image or an error image, and
the controller controls the oscillation of the oscillation device such that oscillation indicating that the error image has been acquired is different from oscillation indicating that the normal image has been acquired.

8. The information processing apparatus according to claim 3, wherein
during exposure performed on the imaging device, the controller performs control such that the oscillation of the oscillation device is set to off.

9. The information processing apparatus according to claim 8, wherein
a drive signal of oscillation indicating the reminder information includes a signal that is not given out when an oscillation mode for the oscillation device is off or a signal that is given out when the oscillation mode is off,
when the controller receives, during exposure performed on the imaging device, the reminder information including the signal not being given out when the oscillation mode is off, the controller controls the oscillation device such that the oscillation indicating the reminder information is generated after the exposure performed on the imaging device is completed, and
when the controller receives, during exposure performed on the imaging device, the reminder information including the signal being given out when the oscillation mode is off, the controller controls the oscillation device such that the oscillation indicating the reminder information is generated during the exposure performed on the imaging device.

10. The information processing apparatus according to claim 3, wherein
the reminder information includes at least one of information regarding a remaining life of a battery that serves as a drive power supply used to drive the image-capturing apparatus, or information regarding the image-capturing-environment information.

11. The information processing apparatus according to claim 3, wherein
a plurality of the attachment devices different from each other is attached to the image-capturing apparatus, and
the controller controls the oscillation of the oscillation device such that oscillation indicating the operation information regarding an operation of the attachment device differs depending on the attachment device of the plurality of the attachment devices.

12. The information processing apparatus according to claim 2, wherein
the controller performs control such that first oscillation and second oscillation that respectively indicate the different pieces of information related to the image-capturing apparatus are distinguishable by the camera operator.

13. The information processing apparatus according to claim 1, wherein
the image-capturing-setting information includes at least one of a setting of a shutter speed, a setting of a frame rate, a setting of a single-shooting mode or a consecutive-shooting mode, or a setting of the image-capturing environment.

14. The information processing apparatus according to claim 1, wherein
the state information regarding a state of the image-capturing apparatus includes at least one of type information regarding the type of the attachment device attached to the camera body, form information regarding the form of the attachment device, holding-state information regarding a state in which the camera operator holds the image-capturing apparatus, or information regarding a remaining life of a drive power supply used to drive the image-capturing apparatus and power consumption of the camera body.

15. The information processing apparatus according to claim 1, wherein
the image-capturing apparatus includes a zoom lens, and
the controller controls the oscillation of the oscillation device taking into consideration oscillation provided during driving of the zoom lens.

16. The information processing apparatus according to claim 1, wherein
the controller controls the oscillation of the oscillation device taking into consideration oscillation sound produced due to the oscillation device.

17. The information processing apparatus according to claim 1, wherein
the image-capturing apparatus includes a mechanical shutter, and
the controller controls the oscillation of the oscillation device taking into consideration oscillation provided when the mechanical shutter is operated.

18. The information processing apparatus according to claim 1, wherein
the controller controls next oscillation of the oscillation device using oscillation information regarding oscillation of the image-capturing apparatus.

19. An information processing method, comprising
controlling oscillation of an oscillation device that provides oscillation to a camera operator, on a basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.

20. A program that causes an information processing apparatus to perform a process comprising
controlling oscillation of an oscillation device that provides oscillation to a camera operator, on a basis of at least one of image-capturing-environment information regarding an environment of image-capturing performed by an image-capturing apparatus, image-capturing-setting information that is set by the camera operator, or state information regarding a state of the image-capturing apparatus, the image-capturing apparatus including the oscillation device and an imaging device that captures an image of a subject.
